(19) United States
(12) Patent Application Publication
(10) Pub. No.: US 2024/0286702 A1
(43) Pub. Date: Aug. 29, 2024

(54) PERSONAL MOBILITY DEVICE HAVING INTEGRATED CARRYING FUNCTIONALITY

(71) Applicant: Jetson Electric Bike LLC, Brooklyn, NY (US)

(72) Inventors: Tyler Serra, Brooklyn, NY (US); Alexander Chatham, Brooklyn, NY (US); Tadhg Duffy, Brooklyn, NY (US); Thomas Laughlin, JR., Northport, NY (US); Antony Orsini, Cheshire, CT (US)

(73) Assignee: Jetson Electric Bike LLC, Brooklyn, NY (US)

(21) Appl. No.: 18/589,591

(22) Filed: Feb. 28, 2024

Related U.S. Application Data
(60) Provisional application No. 63/487,357, filed on Feb. 28, 2023.

(51) Int. Cl. B62K 15/00; B62J 15/00; B62K 21/18

(52) U.S. Cl. CPC B62K 15/006; B62J 15/00; B62K 21/18

(57) ABSTRACT

In an embodiment, a personal mobility device is disclosed. The personal mobility device comprises a wheel, a stem and a base. The stem is configured to fold relative to the base to transition the personal mobility device between an open configuration and a folded configuration. The personal mobility device further comprises an integrated carrying mechanism attached to the personal mobility device. The integrated carrying mechanism comprises a flexible material that is configured for use by a user to carry the personal mobility device when in the folded configuration.

### RELATED APPLICATIONS

This application claims priority to U.S. Provisional Patent Application No. 63/487,357 filed Feb. 28, 2023, entitled “Personal Mobility Device Having Integrated Carrying Functionality,” which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

This application relates to personal mobility devices, and in particular, to personal mobility devices that have integrated carrying functionality.

Personal mobility devices such as scooters, bicycles, etc., are often used to transport a user from place to place. For example, the user may use the personal mobility device to travel between their home and a place of employment, a location associated with another type of transportation such as a train station or bus stop, or to any other location. Regardless of their use, the user of such a personal mobility devices may need to pick up and carry the personal mobility device. For example, the user may need to pick up and carry the personal mobility device onto a bus or train, up or down a stair case, into a building or to another location that may not allow the use of the personal mobility device. In some cases, the user may also wish to collapse or fold the personal mobility device for storage.

### SUMMARY

In an embodiment, a personal mobility device is disclosed. The personal mobility device comprises a wheel, a stem and a base. The stem is configured to fold relative to the base to transition the personal mobility device between an open configuration and a folded configuration. The personal mobility device further comprises an integrated carrying mechanism attached to the personal mobility device. The integrated carrying mechanism comprises a flexible material that is configured for use by a user to carry the personal mobility device when in the folded configuration.

In an embodiment, the integrated carrying mechanism is tensioned when the personal mobility device is in the open configuration and is configured to automatically loosen when the personal mobility device is transitioned from the open configuration to the folded configuration.

In an embodiment, the integrated carrying mechanism is attached to the stem at a first attachment location and attached to the base at a second attachment location, the integrated carrying mechanism extending from the first attachment location to the second attachment location through an opening of the stem.

In an embodiment, a distance between the first attachment location and the second attachment location in the open configuration is greater than the distance between the first attachment location and the second attachment location in the folded configuration.

In an embodiment, the stem comprises a member extending across the opening. The integrated carrying mechanism is tensioned against the member when the personal mobility device is in the open configuration and loosened relative to the member when the personal mobility device is in the folded configuration.

In an embodiment, the flexible material comprises a first flexible material and the integrated carrying mechanism comprises a second flexible material. The second flexible material is configured for use by a user to carry the personal mobility device when in the folded configuration.

In an embodiment, the first and second flexible materials are configured for use by a user to carry the personal mobility device on a back like a backpack.

In an embodiment, the personal mobility device comprises a scooter having two or more wheels.

In an embodiment, the integrated carrying mechanism is attached to the personal mobility device at a first attachment location and at a second attachment location. The flexible material is tensioned toward at least one of the first attachment location and the second attachment location.

In an embodiment, the personal mobility device is configured to be held by a user lengthwise on edge.

In an embodiment, the integrated carrying mechanism is fixedly attached to a first attachment location of the personal mobility device and removably attached to a second attachment location of the personal mobility device.

In an embodiment, the first attachment location and the second attachment location are on the stem.

In an embodiment, the first attachment location is on a handlebar of the stem and the second attachment location is on a bracket coupling the stem to the base.

In an embodiment, the integrated carrying mechanism is configured for retraction to the first attachment location.

In an embodiment, a personal mobility device is disclosed. The personal mobility device comprises a base, a stem comprising a first end portion and a second end portion, a handlebar coupled to the first end portion of the stem, and a folding mechanism coupled to the second end portion of the stem and being configured to transition the stem between an open configuration and a folded configuration. The first and second end portions of the stem are disposed proximate to the base when the stem is in the folded configuration. The stem comprises a handle portion disposed between the folding mechanism and the handlebar. The handle portion is disposed proximate to a center of gravity of the personal mobility device.

In an embodiment, the stem is wider than the base.

In an embodiment, the stem comprises an opening between a first arm and a second arm. The stem is configured to receive at least a portion of the base in the opening when the stem is in the folded configuration such that the first and second arms are disposed on opposite sides of the portion of the base.

In an embodiment, the handle portion of the stem is configured to transition between a first configuration and a second configuration. The stem at the handle portion has a width that is greater than a corresponding portion of the base when the handle portion is in the first configuration and a width that is smaller than the corresponding portion of the base when the handle portion is in the second configuration.

In an embodiment, the base comprises a recess located proximate to the handle portion of the stem when the stem is in the folded configuration. The recess is configured to receive a portion of a user's hand when the user grasps the handle portion of the stem.

In an embodiment, a personal mobility device is disclosed. The personal mobility device comprises a base a stem comprising a first end portion and a second end portion and a folding mechanism that is configured to transition the stem between an open configuration and a folded configuration. The first and second end portions of the stem are disposed proximate to the base when the stem is in the folded configuration. The base comprises a handle portion disposed proximate to a center of gravity of the personal mobility device when the stem is in the folded configuration.

In an embodiment, a personal mobility device is disclosed. The personal mobility device comprises a wheel and an integrated cover. The integrated cover is configured to selectively cover and uncover a portion of the wheel.

In an embodiment, the integrated cover is selectively translatable between a first position in which the portion of the wheel is uncovered and a second position in which the portion of the wheel is covered.

In an embodiment, the personal mobility device further comprises a fender and the integrated cover is at least partially disposed within the fender when the in the first position.

In an embodiment, the fender defines a semi-circular shape. The integrated cover is disposed at least partially within the semi-circular shape of the fender when in the first position.

In an embodiment, the integrated cover defines a semi-circular shape. The integrated cover is concentrically nested within the fender when in the first position.

In an embodiment, the integrated cover is at least partially extended from the fender when in the second position.

In an embodiment, the integrated cover is selectively actuatable by a user to transition the integrated cover between the first position and the second position.

In an embodiment, the integrated cover is configured to automatically transition between the first position and the second position.

In an embodiment, the automatic transition of the integrated cover between the first position and the second position is based at least in part on a transition of the personal mobility device from an open configuration in which the personal mobility device is configured for use and a folded configuration in which the personal mobility device is configured for carrying or storage.

In an embodiment, the cover is configured to inhibit the end user from coming into contact with the portion of the wheel when the cover selectively covers the portion of the wheel.

In an embodiment, a personal mobility device is disclosed. The personal mobility device comprises a base, a wheel, a stem and a folding mechanism that is configured to transition the stem from an open configuration to a folded configuration. The stem is configured to cover at least a portion of the wheel when in the folded configuration.

In an embodiment, a personal mobility device is disclosed. The personal mobility device comprises a base, a stem comprising a first end portion and a second end portion, a handlebar coupled to the first end portion of the stem, a wheel coupled to the second end portion of the stem and a folding mechanism coupled to the stem between the first end portion and the second end portion. The folding mechanism is configured to transition the stem from an open configuration to a folded configuration. The stem is disposed proximate to the base when in the folded configuration.

In an embodiment, the second end portion of the stem comprises a standing surface. The standing surface extends longitudinally forward of the base when the stem is in the folded configuration. The standing surface is configured for engagement against an environmental surface such that a longitudinal axis of the base is roughly perpendicular to the environmental surface when the stem is in the folded configuration. The standing surface is configured to inhibit the personal mobility device from falling over when the standing surface is engaged against the environmental surface.

In an embodiment, the standing surface defines a plane of contact for engaging an environmental surface. An axis extending perpendicular from the plane through a center of mass of the personal mobility device is located within the standing surface.

In an embodiment, the first end portion of the stem comprises a handle disposed above the center of mass relative to the plane.

In an embodiment, the wheel and standing surface together define a plane of contact for engaging the environmental surface. The wheel is configured to contact the plane at a first location. The standing surface is configured to contact the plane at a second location. An axis extending perpendicular to the plane through a center of mass of the personal mobility device is located between first and second locations on the plane.

In an embodiment, the first end portion of the stem comprises a handle disposed above the center of mass relative to the plane.

In an embodiment, the first end portion of the stem comprises a grip portion and the wheel is exposed relative to the base when the stem is in the folded configuration. The wheel being configured to engage against an environmental surface when a user holds the grip portion such that a longitudinal axis of the personal mobility device when in the folded configuration is at an acute angle relative to the environmental surface.

In an embodiment, a personal mobility device is disclosed. The personal mobility device comprises a base, a stem, a bracket coupled to the stem, a wheel coupled to the bracket and a folding mechanism coupled to the bracket. The folding mechanism is configured to transition the stem from an open configuration to a folded configuration. The stem is disposed proximate to the base when in the folded configuration. The wheel extends forward of the base when the stem is in the folded configuration. The bracket comprises a standing surface that extends forward of the base at least as far forward as the wheel when the stem is in the folded configuration.

In an embodiment, the standing surface is configured for engagement against an environmental surface such that a longitudinal axis of the base is transverse to the environmental surface when the stem is in the folded configuration, the standing surface is configured to inhibit the personal mobility device from falling over when the standing surface is engaged against the environmental surface and the standing surface defines a plane of contact for engaging the environmental surface.

In an embodiment, an axis extending perpendicular to the plane through a center of mass of the personal mobility device extends through the standing surface.

In an embodiment, the wheel is aligned with the standing surface when the stem is in the folded configuration and the wheel and the standing surface together define the plane of contact for engaging the environmental surface.

In an embodiment, the wheel is configured to contact the plane at a first location, the standing surface is configured to contact the plane at a second location and an axis extending perpendicular to the plane through a center of mass of the personal mobility device is located between first and second locations on the plane.

In an embodiment, the stem comprises a handle disposed above the center of mass relative to the plane.

In an embodiment, the stem comprises a grip portion and the wheel is exposed relative to the base when the stem is in the folded configuration. The wheel is configured to engage against an environmental surface when a user holds the grip portion such that a longitudinal axis of the personal mobility device when in the folded configuration is at an acute angle relative to the environmental surface.

In an embodiment, a personal mobility device is disclosed. The personal mobility device comprises a stem and a base. The stem is configured to fold relative to the base to transition the personal mobility device between an open configuration and a folded configuration. The personal mobility device further comprises an integrated carrying mechanism attached the stem at a first attachment location and the base at a second attachment location. The integrated carrying mechanism is configured to automatically tension against a portion of the stem when the personal mobility device is transitioned to the open configuration and to automatically loosen when the personal mobility device transition to the folded configuration.

In an embodiment, the integrated carrying mechanism extends through an opening in the stem. The integrated carrying mechanism is tensioned against a side of the opening when the personal mobility device is in the open configuration and loosened relative to the side of the opening when the personal mobility device is in the folded configuration.

In an embodiment, the opening is disposed a first distance from the second attachment location when the personal mobility device is in the open configuration and a second distance from the second attachment location when the personal mobility device is in the folded configuration. The second distance is smaller than the first distance.

In an embodiment, the personal mobility device comprises a folding mechanism coupled to the stem and the base and configured to fold the stem relative to the base and the integrated carrying mechanism extends through an opening in the folding mechanism.

In an embodiment, a personal mobility device is disclosed. The personal mobility device comprises a wheel, a fender covering a first portion of the wheel, an integrated cover that is configured to selectively cover a second portion of the wheel, a base comprising a body and a distal portion extending from the body and a stem foldable relative to the base to transition the personal mobility device between an open configuration and a folded configuration. The wheel is coupled to the distal portion and is rotatable about a longitudinal axis of the distal portion between a first position and a second position. The wheel is configured to lay flat adjacent the stem when the personal mobility device is in the folded configuration.

In an embodiment, a personal mobility device is disclosed. The personal mobility device comprises a base comprising a body and a distal portion extending from the body, a stem foldable relative to the base to transition the personal mobility device between an open configuration and a folded configuration and a wheel coupled to the distal portion. The wheel is rotatable about a longitudinal axis of the distal portion between a first position and a second position.

In an embodiment, the distal portion is rotatable relative to the body to rotate the wheel between the first position and the second position.

In an embodiment, the wheel in the second position is rotated 90 degrees relative to the first position.

In an embodiment, the wheel is configured to lay flat adjacent the stem when the personal mobility device is in the folded configuration and the wheel is in the second position.

In an embodiment, the wheel is configured for engaging against an environmental surface when the personal mobility device is in the open configuration and the wheel is in the first position.

In an embodiment, the distal portion is translatable relative to the body to translate the wheel between a third position and a fourth position. The wheel is disposed closer to the body when in the third position than the fourth position.

In an embodiment, a personal mobility device is disclosed. The personal mobility device comprises a base, a stem and a folding mechanism that is configured to transition the stem from an open configuration to a folded configuration. The stem is configured to fold flat against the base when in the folded configuration. The folding mechanism comprises a first joint coupled to the stem and a second joint coupled to the base. The folding mechanism is configured to rotate about each of the first and second joints to fold the stem flat against the base.

In an embodiment, the stem and wheel together are configured to move in a rearward direction toward the base when the stem is transitioned from the open configuration to the folded configuration.

In an embodiment, the stem members comprise standing surfaces. The standing surfaces are exposed forward of the wheel when the stem is in the folded configuration. The standing surfaces are configured for standing the personal mobility device on a surface separate from the personal mobility device and to inhibit the personal mobility device from falling over.

In an embodiment, the base comprises a platform. A height of the base adjacent to the platform is smaller than a height of the arm members, a height of the stem is smaller than a height of the arm members and a combined height of the base adjacent the platform and the height of the stem is about the same as the height of the arm members when the stem is folded flat against the base in the folded configuration.

In an embodiment, a personal mobility device is disclosed. The personal mobility device comprises a base and a bracket coupled to the base by a first joint. The bracket is coupled to a wheel. The personal mobility device further comprises a stem comprising an arm member coupled to the bracket by a second joint. The stem is rotatable about the second joint to transition the stem from an open configuration to a folded configuration. The stem is configured to fold flat against the base when in the folded configuration.

In an embodiment, an axis of rotation of the second joint is offset from an axis of rotation of the wheel, an axis of rotation of the second joint is also offset from a platform of the base in a direction perpendicular to the platform and the bracket is configured to rotate the wheel relative to the base about the first joint.

In an embodiment, the bracket comprises a stand. The stand and wheel both are configured to simultaneously engage against a surface separate from the personal mobility device when the personal mobility device is stood up in the folded configuration. The stand being configured to inhibit personal mobility device from falling over when stood up.

In an embodiment, a personal mobility device is disclosed. The personal mobility device comprises a base comprising a platform, a first side and a second side opposite the first side. The personal mobility device further comprises a bracket coupled to the base by a first joint and coupled to a wheel. The personal mobility device further comprises a first stem member coupled to the bracket by a second joint. The first stem member is rotatable about the second joint to transition the personal mobility device from an open configuration to a folded configuration.

The first stem member is disposed adjacent to the first side of the base when the personal mobility device is in the folded configuration. The personal mobility device further comprises a second stem member coupled to the bracket by a third joint. The second stem member is rotatable about the third joint to transition the personal mobility device from the open configuration to the folded configuration. The second stem member is disposed adjacent to the second side of the base when the personal mobility device is in the folded configuration.

In an embodiment, the bracket comprises a stand. The stand and wheel both are configured to simultaneously engage against a surface separate from the personal mobility device when the personal mobility device is stood up in the folded configuration. The stand is configured to inhibit personal mobility device from falling over when stood up.

The foregoing summary is illustrative only and is not intended to be in any way limiting. These and other illustrative embodiments include, without limitation, apparatus, systems, methods and computer-readable storage media. In addition to the illustrative aspects, embodiments, and features described above, further aspects, embodiments, and features will become apparent by reference to the drawings and the following detailed description.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 is a perspective view of an example personal mobility device in an open configuration according to an embodiment.

FIG. 2 is a perspective view of the personal mobility device of FIG. 1 in a folded configuration according to an embodiment.

FIG. 3 is a front view of a front portion of the personal mobility device of FIG. 2 showing the personal mobility device standing on a surface according to an embodiment.

FIG. 4 is a perspective view of the personal mobility device of FIG. 1 from a rear perspective according to an embodiment.

FIG. 5 is a perspective cut-away view of the personal mobility device of FIG. 1 according to an embodiment.

FIG. 6 an expanded perspective cut-away view of a front portion of the personal mobility device of FIG. 5 according to an embodiment.

FIG. 7 is a perspective cut-away view of the personal mobility device of FIG. 2 according to an embodiment.

FIG. 8 is a side view of the personal mobility device of FIG. 1 with the front wheel engaged on a surface during taxiing according to an embodiment.

FIG. 9 is a perspective view of an example personal mobility device in an open configuration according to an embodiment.

FIG. 10 is a perspective view of the personal mobility device of FIG. 9 in a folded configuration according to an embodiment.

FIG. 11 is an expanded side view of a front portion of the personal mobility device of FIG. 10 showing the personal mobility device standing on a surface according to an embodiment.

FIG. 12 is an expanded front view of a handle portion of the personal mobility device of FIG. 10 according to an embodiment.

FIG. 13 is a side view of the personal mobility device of FIG. 10 with the front wheel engaged on a surface during taxiing according to an embodiment.

FIG. 14 is a perspective view of an example personal mobility device in an open configuration according to an embodiment.

FIG. 15 is an expanded perspective view of a rear portion of the personal mobility device of FIG. 14 in a folded configuration according to an embodiment.

FIG. 16 is a perspective view of the personal mobility device of FIG. 14 in a folded configuration according to an embodiment.

FIG. 17 is an expanded front view of a front portion of the personal mobility device of FIG. 16 showing the personal mobility device standing on a surface according to an embodiment.

FIG. 18 is a perspective view of an example personal mobility device having standing surfaces on a stem in an open configuration according to an embodiment.

FIG. 19 is a perspective view of the personal mobility device of FIG. 18 in a folded configuration according to an embodiment.

FIG. 20 is a side view of the personal mobility device of FIG. 16 with the front wheel engaged on a surface during taxiing according to an embodiment.

FIG. 21 is a side view of a rear portion of the personal mobility device of FIG. 14 according to an embodiment.

FIG. 22 is a side cut-away view of the rear portion of the personal mobility device of FIG. 21 showing a cover nested within a fender according to an embodiment.

FIG. 23 is a side view of a rear portion of the personal mobility device of FIG. 21 showing the cover partially extended according to an embodiment.

FIG. 24 is a side cut-away view of the rear portion of the personal mobility device of FIG. 23 showing the cover partially extended according to an embodiment.

FIG. 25 is a side view of a rear portion of the personal mobility device of FIG. 21 showing the cover fully extended according to an embodiment.

FIG. 26 is a side cut-away view of the rear portion of the personal mobility device of FIG. 25 showing the cover fully extended according to an embodiment.

FIG. 27 is a perspective view of an example personal mobility device in an open configuration according to an embodiment.

FIG. 28 is another perspective view of the personal mobility device of FIG. 27 in the open configuration according to an embodiment.

FIG. 29 is a perspective view of the personal mobility device of FIG. 27 in a folded configuration standing on a surface according to an embodiment.

FIG. 30 is a side view of the personal mobility device of FIG. 29 standing on the surface according to an embodiment.

FIG. 31 is another perspective view of the personal mobility device of FIG. 27 in the folded configuration according to an embodiment.

FIG. 32 is a top-down view of the personal mobility device of FIG. 31 in the folded configuration according to an embodiment.

FIG. 33 is a top-down view of the personal mobility device of FIG. 32 showing a strap according to an embodiment.

FIG. 34 is another top-down view of the personal mobility device of FIG. 33 according to an embodiment.

FIG. 35 is a perspective view of the personal mobility device of FIG. 31 showing a strap according to another embodiment.

FIG. 36 is a side view of the personal mobility device of FIG. 35 according to an embodiment.

FIG. 37 is a perspective view of the personal mobility device of FIG. 31 showing a pair of straps according to another embodiment.

FIG. 38 is a perspective view of another embodiment of the personal mobility device of FIG. 27 in the folded configuration with handle portions disposed toward each other according to an embodiment.

FIG. 39 is a perspective view of the personal mobility device of FIG. 38 with the handle portions partially rotated according to an embodiment.

FIG. 40 is a perspective view of the personal mobility device of FIG. 38 with the handle portions rotated away from each other according to an embodiment.

FIG. 41 is a side view of the personal mobility device of FIG. 27 with the front wheel engaged on a surface during taxiing according to an embodiment.

FIG. 42 is a perspective view of an example personal mobility device having a carrying mechanism according to an embodiment.

FIG. 43 is an expanded perspective view of the handlebar of the personal mobility device of FIG. 42 showing the strap retracted into the handlebar according to an embodiment.

FIG. 44 is an expanded perspective view of the handlebar of the personal mobility device of FIG. 42 showing the strap partially extended from the handlebar according to an embodiment.

FIG. 45 is a perspective view of the personal mobility device of FIG. 42 showing the strap partially extended from the handlebar according to an embodiment.

FIG. 46 is an expanded perspective view of the stem of the personal mobility device of FIG. 42 showing the strap partially extended to an attachment point in the stem according to an embodiment.

FIG. 47 is a perspective view of an example personal mobility device having recessed portions in a base according to an embodiment.

FIG. 48 is a perspective view of the personal mobility device of FIG. 47 having grip portions extending across the recessed portions according to an embodiment.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

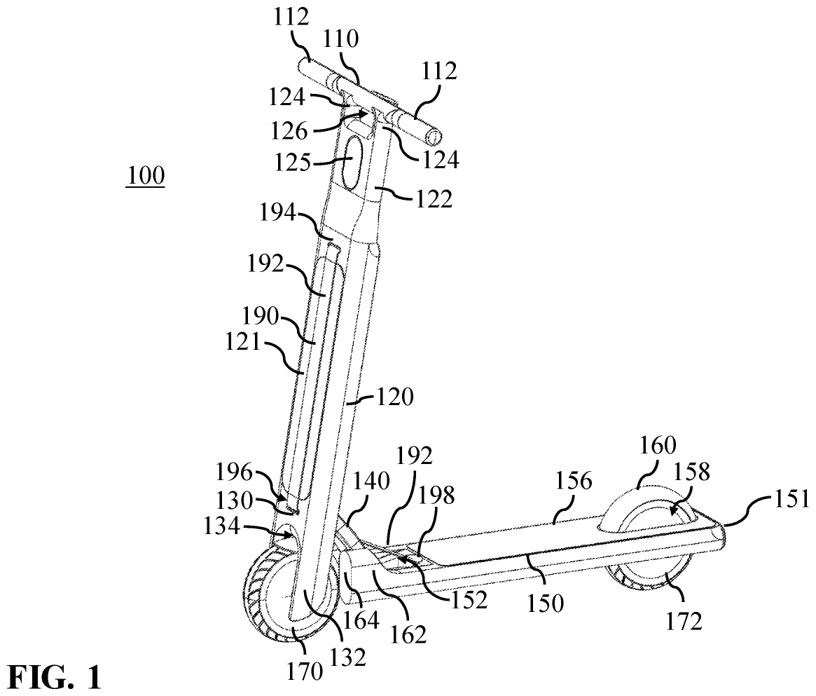

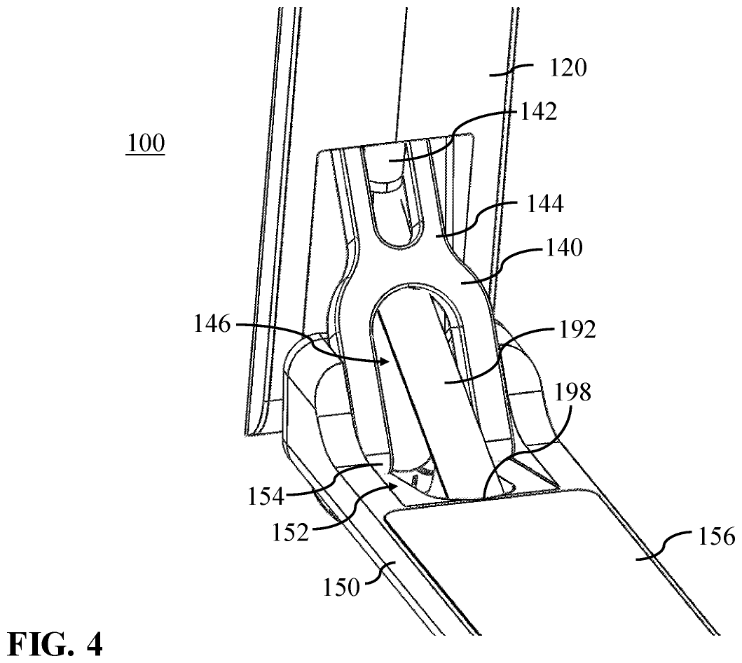

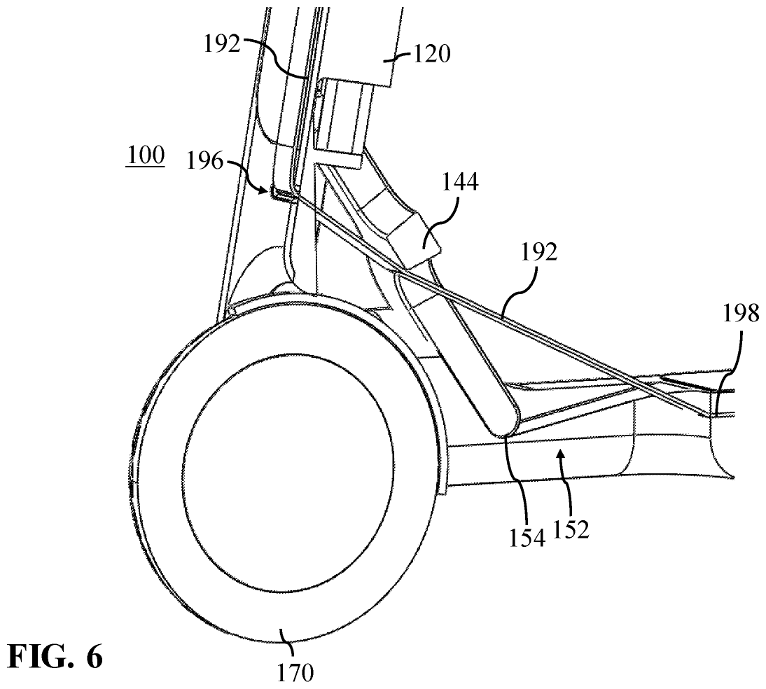

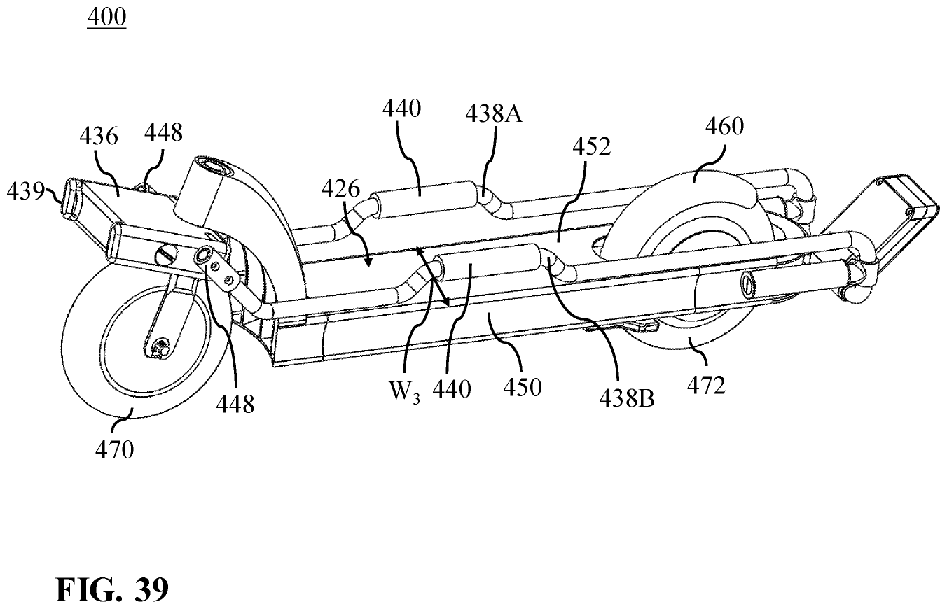

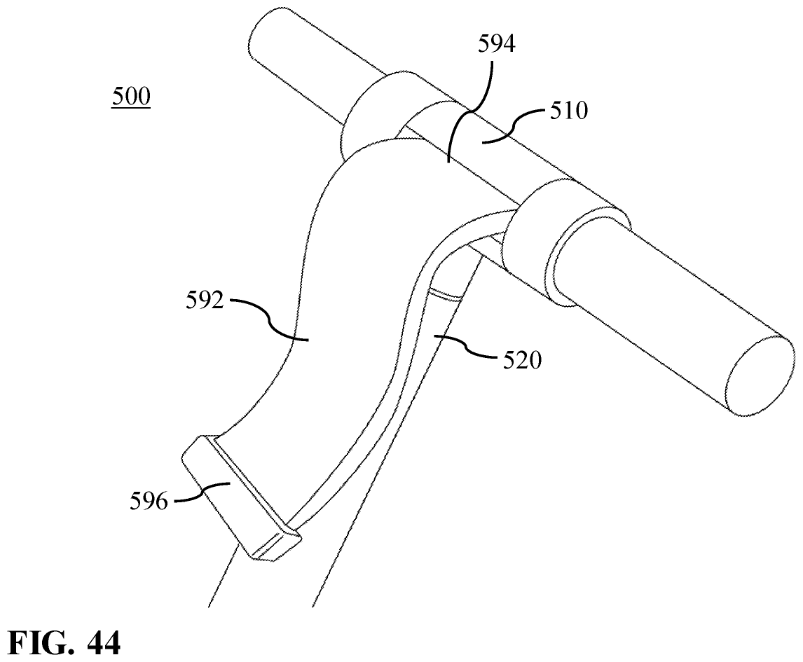

FIGS. 1-48 illustrate example embodiments of personal mobility devices that have integrated carrying functionality including personal mobility devices 100, 200, 300, 400, 500 and 600. While various features are embodiments are described with reference to a particular personal mobility device 100, 200, 300, 400, 500 and 600 in illustrative embodiments, any of the features and components of each personal mobility device may also or alternatively be utilized with each other personal mobility device 100, 200, 300, 400, 500 and 600 in other embodiments without departing from the scope of the present disclosure.

With reference to FIGS. 1-8, an example embodiment of personal mobility device 100 is disclosed. Personal mobility device 100 is configured to provide a user with personal mobility, e.g., personal transportation from place to place. In an illustrative embodiment, personal mobility device 100 comprises a scooter, e.g., as shown in FIG. 1. In other embodiments, personal mobility device 100 may comprise other devices that may be used to transport a user including bicycles, skateboards, unicycles, hoverboards, tricycles, 3-wheels, ride-ons, strollers, carts or any other personal mobility device. In some embodiments, personal mobility device 100 comprises a user powered personal mobility device, e.g., movement of the personal mobility device is caused by physical effort of the user such as by kicking, dragging, running, pushing or otherwise driving a movement of personal mobility device. In some embodiments, personal mobility device 100 comprises a powered personal mobility device, e.g., comprising an electric or other type of motor that is configured to cause movement of personal mobility device 100 by driving one or more of the wheels of personal mobility device 100 or in any other manner.

In some embodiments, personal mobility device 100 may comprise some features or components that are similar to those found on one or more of personal mobility devices 200, 300, 400, 500 and 600. Where possible, similar features and components will be referred to with similar reference numbers. In addition, any of the features or features described herein with respect to personal mobility devices 200, 300, 400, 500 and 600 may be utilized in personal mobility device 100 and vice versa in various embodiments without departing from the scope of the present disclosure.

Personal mobility device 100 comprises a handlebar 110, stem 120, folding mechanism 140, base 150, a wheel 170, a wheel 172 and a carrying mechanism 190. In other embodiments, other configurations may alternatively be utilized including, e.g., an alternate handlebar 110, stem 120, folding mechanism 140, base 150, wheels 170 and 172, carrying mechanism 190 or any other alternative components or configurations including those shown in the other embodiments provided herein.

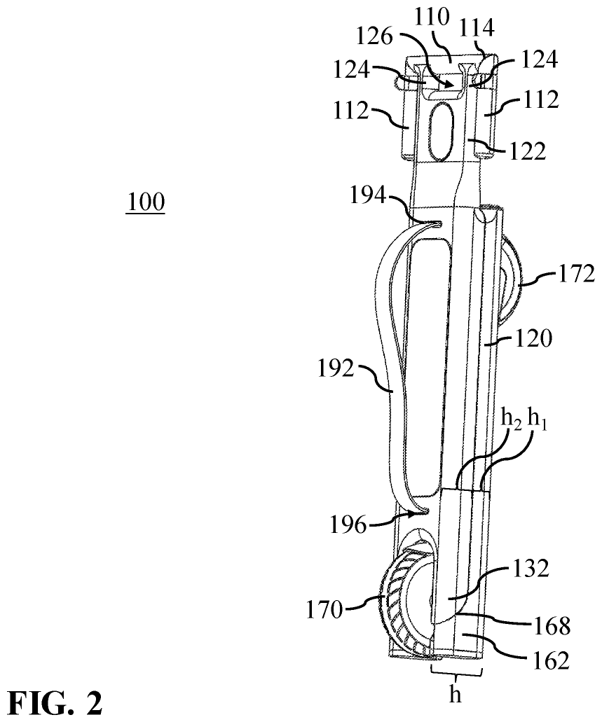

Handlebar 110 comprises handles 112 that are configured to collapse or fold from an extended position, also referred to as a first position, such as shown in FIG. 1 to a collapsed or folded position, also referred to as a second position, such as shown in FIG. 2. Handles 112 may collapse or fold, for example, by bending, twisting, rotating, or in any other manner. In some embodiments, for example, handles 112 comprise an angled folding mechanism 114 such as shown in FIG. 2 where, for example, handles 112 may be configured to rotate about folding mechanism 114 from the first position (FIG. 1) to the second position (FIG. 2). In some embodiments, folding mechanism 114 may have a 45-degree angle. In other embodiments, any other angle may be utilized for folding mechanism 114.

Handlebar 110 is attached to an end portion 122 of stem 120. End portion 122 comprises arm members 124 that are configured to engage handlebar 110 and secure handlebar 110 to stem 120. In some embodiments, stem 120 defines a channel or opening 126 between arm members 124 such that when handlebar 110 is attached to arm members 124, opening 126 provides a hole through which an object may be passed between handlebar 110 and stem 120, e.g., a hand or another object. In other embodiments, arm members 124 may comprise a single arm member 124 that extends from end portion 124 to handlebar 110 without having an opening 126. When in the collapsed or folded position, handles 112 are positioned proximate to end portion 122 of stem 120, and in some embodiments, in contact with end portion 122 of stem 120. Stem further comprises a headlight 125, e.g., battery powered or powered in another manner, that is configured to illuminate an area in front of personal mobility device 100.

Stem 120 also comprises an end portion 130 opposite end portion 122. End portion 130 comprises arm members 132 that define a channel 134 therebetween for receipt of wheel 170.

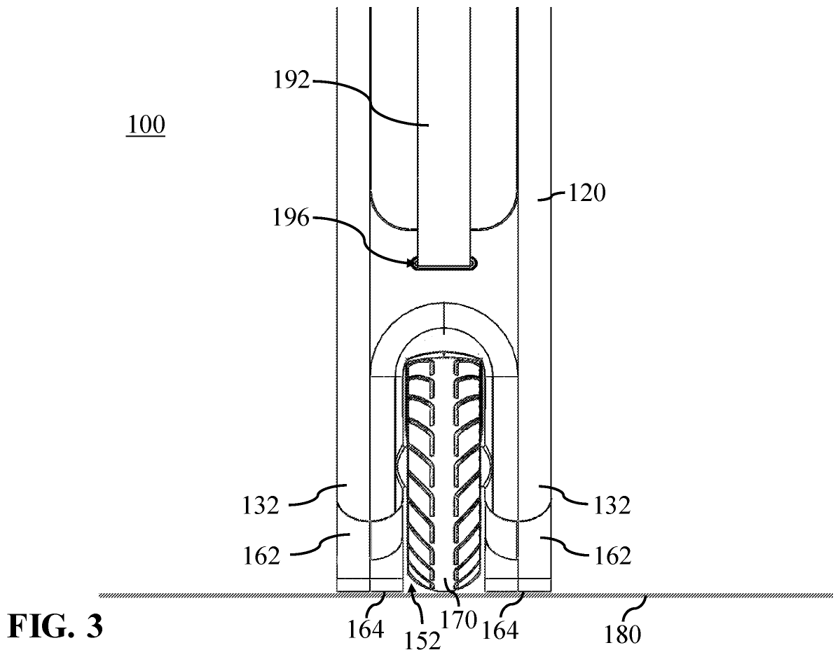

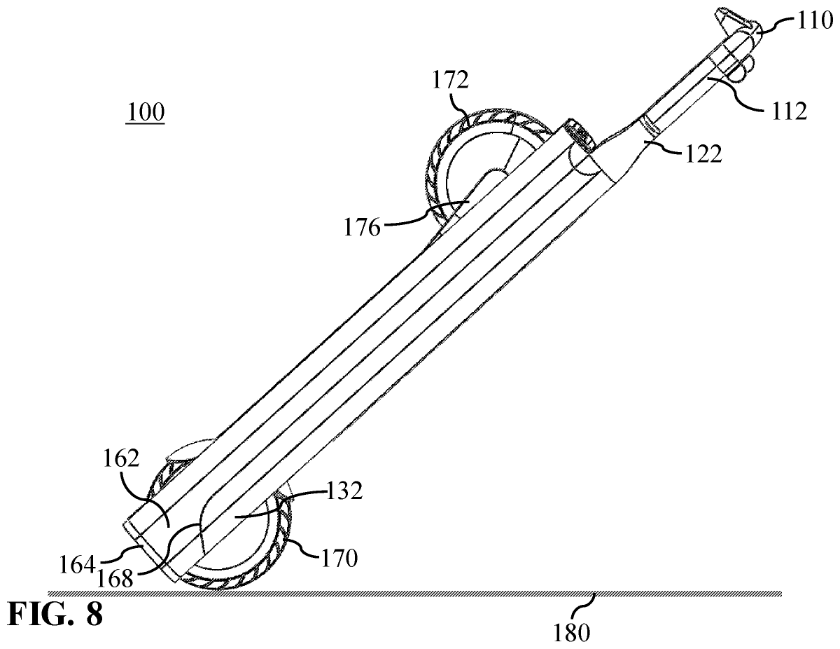

Arm members 132 are configured to engage with wheel 170 to enable rotation of wheel 170 about a central axis of wheel, e.g., using an axle or another component, during movement of personal mobility device 100 across a surface 180 (FIGS. 3 and 8) such as a floor, road, sidewalk, etc. Arm members 132 are also configured to cause a rotation of wheel about a longitudinal axis of stem 120 such that rotation of stem 120 causes a corresponding rotation of wheel 170, e.g., to turn personal mobility device 100.

Stem 120 is attached to base 150 by folding mechanism 140. Folding mechanism 140 is attached to stem 120 at a joint 142 that allows stem 120 to rotate about a longitudinal axis of stem 120 as defined by joint 142 to rotate wheel 170 relative to base 150. In some embodiments, for example, joint 142 comprises a head tube about which stem 120 is configured to rotate, for example, the head tube defines the axis about which stem 120 rotates to rotate wheel 170 relative to base 150 and turn personal mobility device 100.

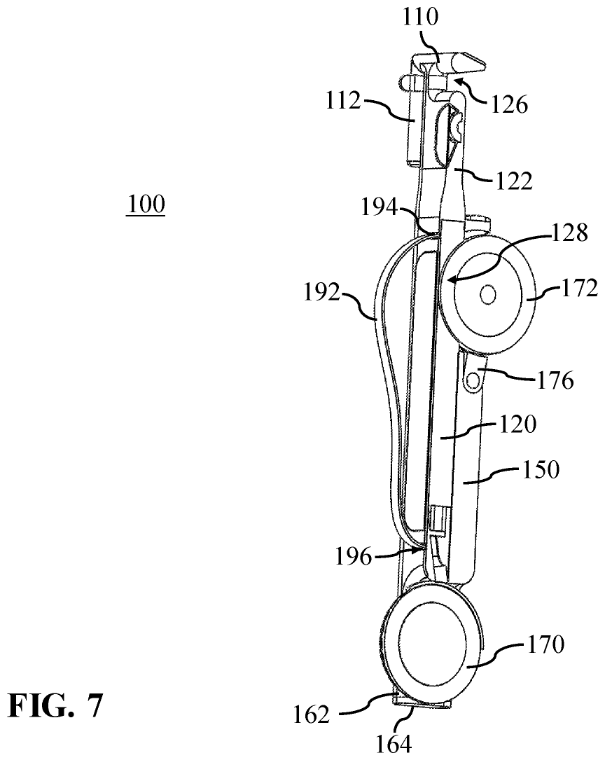

Folding mechanism 140 also comprises a body 144 hinged to and extending from joint 142 into a channel 152 of base 150 and coupled to base 150 at a joint 154, e.g., by a pin, snap-fit or another component or coupling mechanism. Folding mechanism 140 is configured to rotate relative to base 150 around joint 154 to fold stem 120 toward base 150 from an open configuration (FIG. 1) to a folded configuration (FIG. 2). In addition, folding mechanism 140 is configured to rotate relative to stem 120 around the hinged attachment to joint 142. This provides a double-jointed folding mechanism that enables flatter folding of stem 120 relative to base 150. For example, in some embodiments, when stem 120 is folded toward base 150, folding mechanism 140 is received within channel 152 such that stem 120 is disposed in contact with base 150 in the folded configuration, e.g., as shown in FIGS. 2 and 7. In some embodiments, when personal mobility device 100 is in the folded configuration, wheel 170 and stem 120 are inhibited from rotating relative to base 150, e.g., due to engaged of arm member 132 against base 150.

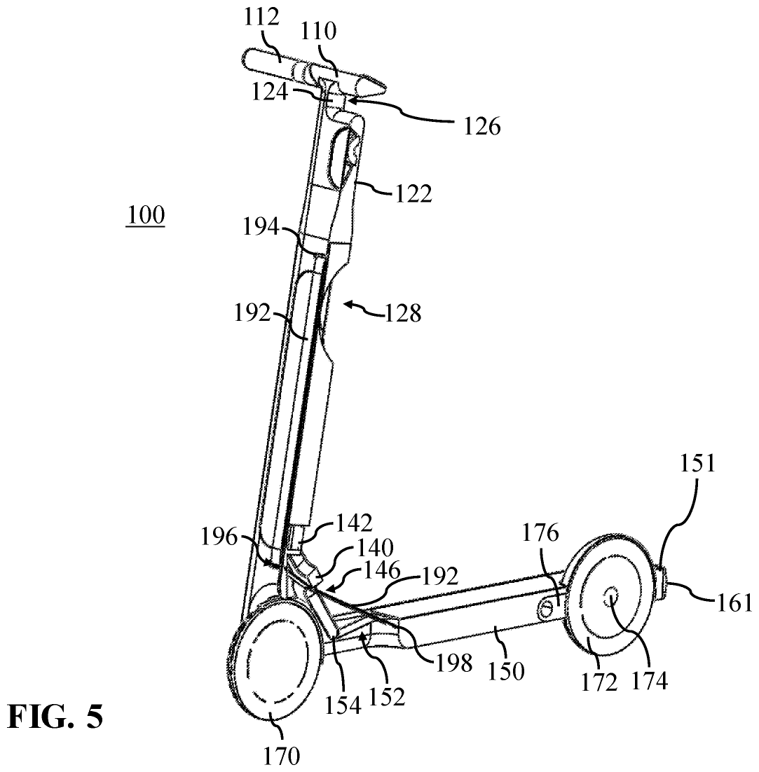

Base 150 comprises a platform 156, sometimes referred to as a deck, and an opening 158 that is configured to receive wheel 172. Opening 158 also comprises a mechanism for attaching wheel 172 to base 150 such as, e.g., an axle 174 (FIG. 5) or other mechanism. In some embodiments, base 150 also comprises a fender 160 at least partially covering wheel 172 and a rear taillight 161 (FIG. 5) disposed in a rear end 151 of base 150 rearward of opening 158. For example, the rear taillight 161 may be disposed within the uniform profile of rear end 151 of base 150.

Base 150 further comprises arms 162 extending toward a front of personal mobility device 100, e.g., in a longitudinal direction relative to base 150, and defining channel 152 therebetween. Arms 162 comprise standing surfaces 164 that are configured for engagement against a surface 180 (FIG. 2) such as a floor, road, sidewalk, etc. As shown in FIG. 1, when stem 120 is in the open configuration, stem 120 and wheel 170 are forward of standing surfaces 164 in the longitudinal direction relative to base 150. When stem 120 is transitioned to the folded configuration, e.g., as shown in FIGS. 2 and 3, stem 120 and wheel 170 are move toward base 150 and at least partially received within channel 152. In the folded configuration, standing surfaces 164 extend equal to or beyond wheel 170 such that when personal mobility device 100 is positioned with standing surfaces 164 engaged against a surface 180 such as a floor, road, sidewalk, etc., personal mobility device 100 is inhibited from falling over.

In some embodiments, as shown in FIGS. 1 and 2, arms 162 define a height h that is greater than a height h₁of the rest of base 150 and a height h₂ of stem 120. In some embodiments, when stem 120 is in the folded configuration as shown in FIG. 2, height h of arms 162 is approximately equal to the combination of height h ₁of base 150 and height h₂ of stem 120. For example, in some embodiments, base 150 defines curved surfaces 168 from height h1 to height h that mirror a corresponding curvature of arm members 132 of stem 120 such that when stem 120 is in the folded configuration, arm members 132 slot into curved surfaces 168 such that stem 120 and base 150 provide a combined height h adjacent arm members 132. In other embodiments, arms 162, standing surfaces 164, base 150 and stem 120 may define any other heights.

As shown in FIGS. 5 and 7, stem 120 comprises a cavity 128 that is configured to at least partially receive wheel 172 when personal mobility device 100 is transitioned to the folded configuration such that stem 120 is able to lay flat against base 150. In some embodiments, wheel 172 may be mounted on a suspension hinge 176 (FIG. 7) such that wheel 172 is able to deflect relative to base 150 when wheel 172 is partially received within cavity 128, e.g., as shown in FIGS. 7 and 8.

With reference now to FIG. 8, personal mobility device 100 may be flipped over when in the folded configuration such that wheel 170 is available to engage against a surface 180 such as a floor, road, sidewalk, etc. In this configuration, a user may pull personal mobility device 100 using handlebar 110 while allowing wheel 170 to roll on the ground, in a similar manner to pulling a piece of luggage. In this configuration, the user may grasp handle 110 with a portion of the user's hand extending into or through opening 126 of stem 120 for ease of comfort and a stable, centrally aligned pulling position.

With reference again to FIGS. 1-8, carrying mechanism 190 comprises a strap 192 attached to stem 120 at an attachment location 194 and extending down through an opening 196 in stem 120, through an opening 146 of folding mechanism 140 and attached to base 150 at an attachment location 198. In some embodiments, strap 192 is permanently affixed to attachment locations 194 and 198. In other embodiments, strap 192 may be removably secured to either or both of attachment locations 194 and 198, for example, using snap-fit, buckles, hook and loop fasteners, or in any other manner.

Carrying mechanism 190 is configured to automatically tighten and loosen depending on the configuration of personal mobility device 100. For example, when personal mobility device 100 is in the open configuration, e.g., as shown in FIG. 1, strap 192 is pulled taught against stem 120 while when personal mobility device 100 is in the folded configuration, e.g., as shown in FIG. 2, strap 192 is automatically loosened such that a user may use strap to carry personal mobility device 100, e.g., by hand, over a shoulder, across the back, or in any other manner. A user may also or alternatively hang personal mobility device 100, e.g., from a hook, banister or in another location or use strap 192 for any other purpose. In some embodiments, stem 120 comprises padding 121 positioned under strap 192 and configured to engaged against the user when the user carries personal mobility device 100 using strap, e.g., on the user's back or in another manner, to provide comfortable carrying to the user.

Strap 192 is automatically loosened and tightened by the transition between the open configuration of FIG. 1 and the folded configuration of FIG. 2. For example, when stem 120 is transitioned from the open configuration to the folded configuration, e.g., by folding stem 120 toward base 150 using folding mechanism 140, the tension on strap 192 caused by stem 120 and folding mechanism 140 is loosened by moving opening 196 in stem 120 and opening 146 in folding mechanism 140 closer to attachment location 198, e.g., as shown in FIGS. 5 through 7. Similarly, when stem 120 is transitioned from the folded configuration to the open configuration, the tension on strap 192 is increased by movement of opening 196 and opening 146 away from attachment location 192. By increasing the tension on strap 192, strap 192 is engaged against a front of stem 120 and kept out of the way to inhibit strap 192 from being caught on any objects while personal mobility device 100 is in use. In this manner, a user need only transition personal mobility device 100 between the folded configuration and the open configuration to either make use of strap 192 or to put strap 192 away for operation of personal mobility device 100 without requiring the user to take any additional steps to otherwise manipulate, attach, or access strap 192. This enables the user to more quickly transition between using and carrying personal mobility device 100.

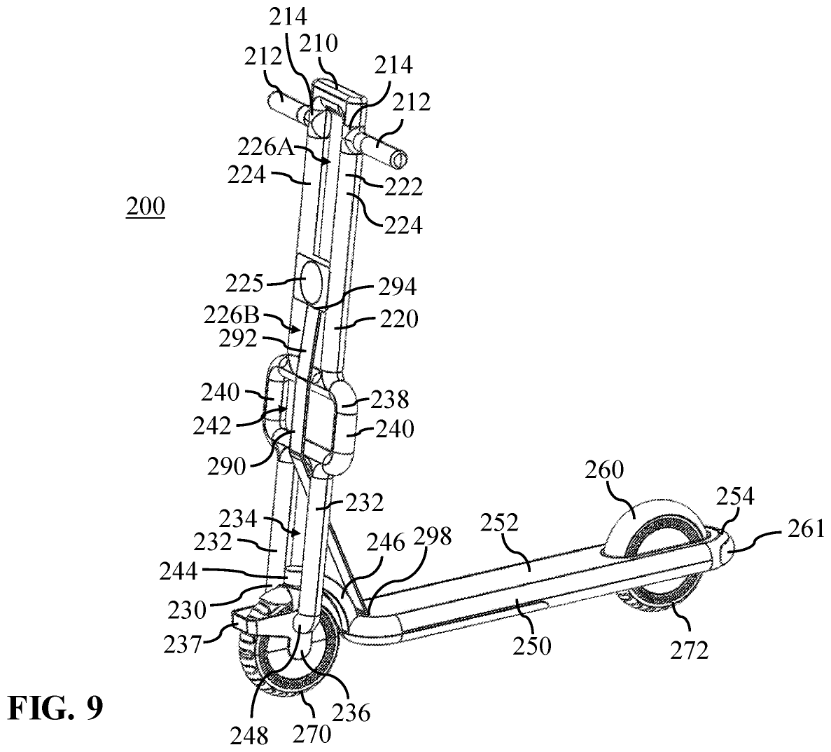

With reference to FIGS. 9-13, an example embodiment of a personal mobility device 200 is disclosed. Personal mobility device 200 is configured to provide a user with personal mobility, e.g., personal transportation from place to place. In an illustrative embodiment, personal mobility device 200 comprises a scooter, e.g., as shown in FIG. 9. In other embodiments, personal mobility device 200 may comprise other devices that may be used to transport a user including bicycles, skateboards, unicycles, hoverboards, tricycles, 3-wheels, ride-ons, strollers, carts or any other personal mobility device. In some embodiments, personal mobility device 200 comprises a user powered personal mobility device, e.g., movement of the personal mobility device is caused by physical effort of the user such as by kicking, dragging, running, pushing or otherwise driving a movement of personal mobility device. In some embodiments, personal mobility device 200 comprises a powered personal mobility device, e.g., comprising an electric or other type of motor that is configured to cause movement of personal mobility device 200 by driving one or more of the wheels of personal mobility device 200 or in any other manner.

In some embodiments, personal mobility device 200 may comprise some features or components that are similar to those found on one or more of personal mobility devices 100, 300, 400, 500 and 600. Where possible, similar features and components will be referred to with similar reference numbers. In addition, any of the features or features described herein with respect to personal mobility devices 100, 300, 400, 500 and 600 may be utilized in personal mobility device 200 and vice versa in various embodiments without departing from the scope of the present disclosure.

Personal mobility device 200 comprises a handlebar 210, a stem 220, a base 250, a wheel 270, a wheel 272 and a carrying mechanism 290. In other embodiments, other configurations may alternatively be utilized including, e.g., an alternate handlebar 210, stem 220, base 250, wheels 270 and 272, carrying mechanism 290 or any other alternative components or configurations including those shown in the other embodiments provided herein.

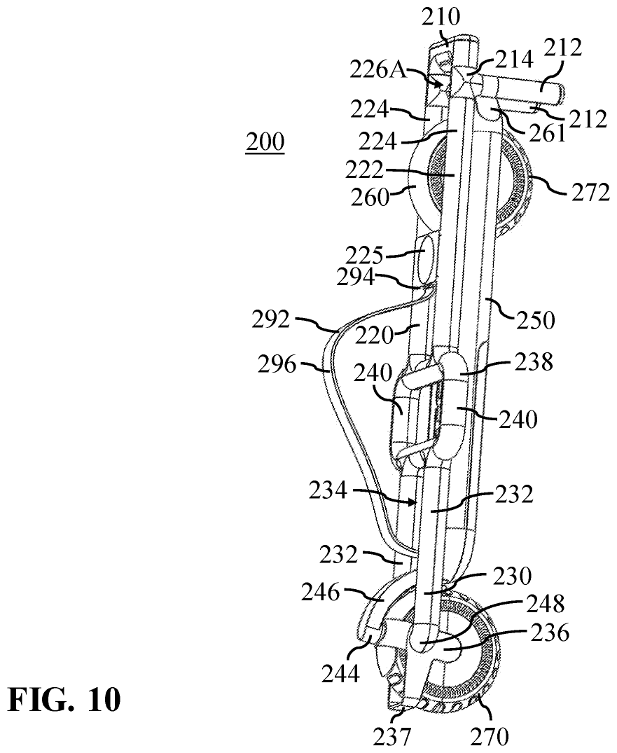

Handlebar 210 comprises handles 212 that are configured to collapse or fold from an extended position, also referred to as a first position, such as shown in FIG. 9 to a collapsed or folded position, also referred to as a second position, such as shown in FIG. 10. Handles 212 may collapse or fold, for example, by bending, twisting, rotating, or in any other manner. In some embodiments, for example, handles 212 are attached to handlebar 210 by a folding mechanism 214 such as shown in FIGS. 9 and 10 where, for example, handles 212 may be configured to rotate with folding mechanism 214 from the first position (FIG. 9) to the second position (FIG. 10). In some embodiments, folding mechanism 214 may rotate handles 212 from the first position to the second position while maintaining a 90-degree angle relative to stem 210. In other embodiments, any other angle may be utilized for handles 212. In some embodiments, handles 212 are disposed in parallel to wheel 272 when in the second position.

Handlebar 210 is attached to an end portion 222 of stem 220. End portion 222 comprises arm members 224 that are configured to engage handlebar 210 and handles 212 and secure handlebar 210 and handles 212 to stem 120. In some embodiments, handlebar 210 is integrated as part of stem 220 with handles 212 being attached to stem 220 via folding mechanism 214. As an example, in an embodiment, folding mechanism 214 for each handle 212 is attached to a corresponding arm member 224 of stem 220 and rotatable about a longitudinal axis of each arm member 214 to transition handles 212 from the first position (FIG. 9) to the second position (FIG. 10).

In some embodiments, stem 220 defines openings 226A and 226B between arm members 224. Openings 226A and 226B provides a hole through which an object may be passed between handlebar 210 and stem 220, e.g., a hand or another object. Stem 220 further comprises a headlight 225, e.g., battery powered or powered in another manner, attached to arm members 224 between openings 226A and 226B that is configured to illuminate an area in front of personal mobility device 200.

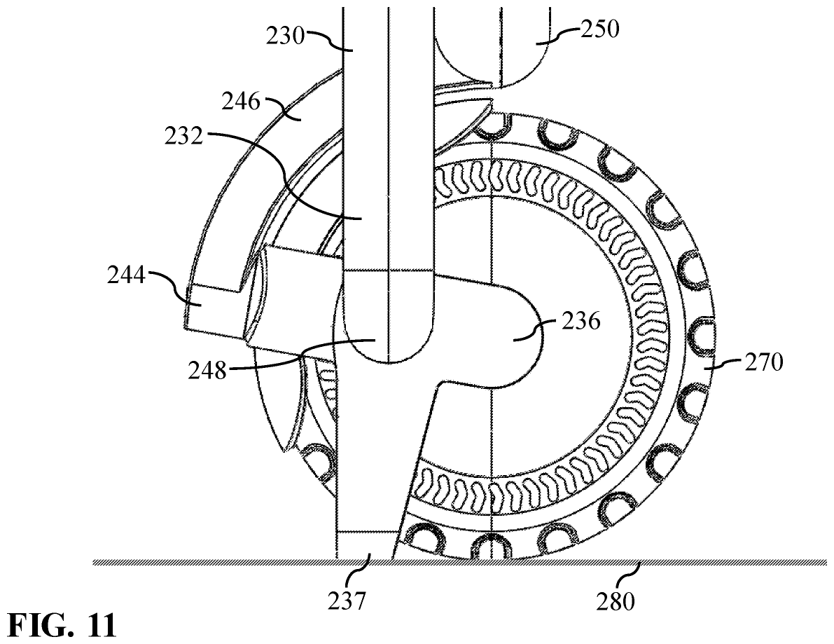

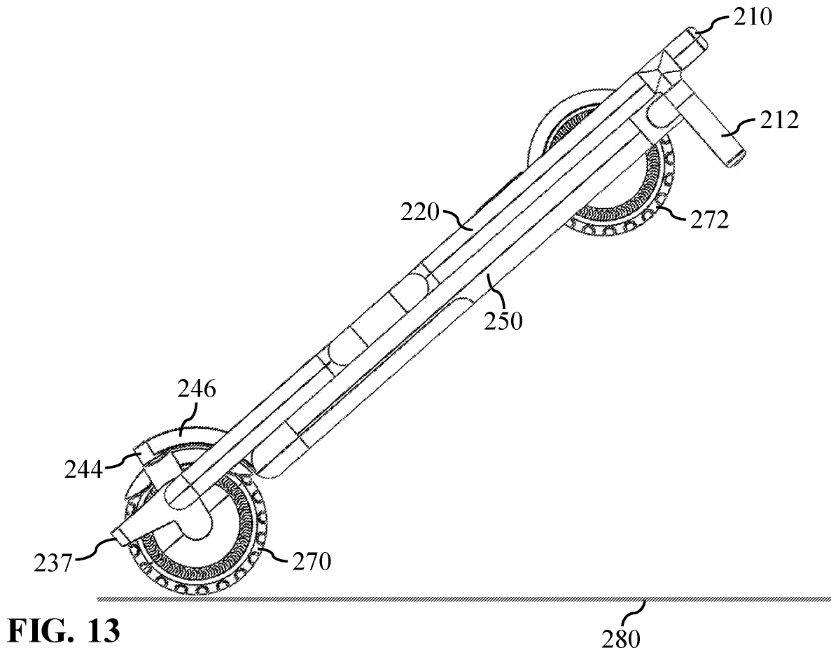

Stem 220 also comprises an end portion 230 opposite end portion 222. End portion 230 comprises arm members 232 that define an opening 234 therebetween. Arm members 232 are attached to a bracket 236 that is attached to wheel 270. In some embodiments, arm members 232 are parallel to each other. Bracket 236 is configured to engage with wheel 270 to enable rotation of wheel 270 about a central axis of wheel, e.g., using an axle or another component, during movement of personal mobility device 200 across a surface 280 (FIGS. 11 and 13) such as a floor, road, sidewalk, etc. In some embodiments, bracket 236 comprises a stand 237 extending toward a front of personal mobility device 200 that is configured, in conjunction with wheel 270, for engagement against a surface 280 to stand up personal mobility device 200 and inhibit personal mobility device 200 from falling when in the folded configuration, e.g., as shown in FIG. 11. In an illustrative embodiment, stand 237 is aligned with the attachment of stem 220 to bracket 236 and offset from the axis of rotation of wheel 270. For example, in some embodiments, as shown in FIGS. 10 and 11, stand 237 may be aligned with a longitudinal axis of stem 220 when stem 220 is folded against base 250 in the folded configuration of personal mobility device 200. In other embodiments, stand 237 may alternatively be offset from the longitudinal axis of stem 220 when stem 220 is folded against base 250 in the folded configuration of personal mobility device 200.

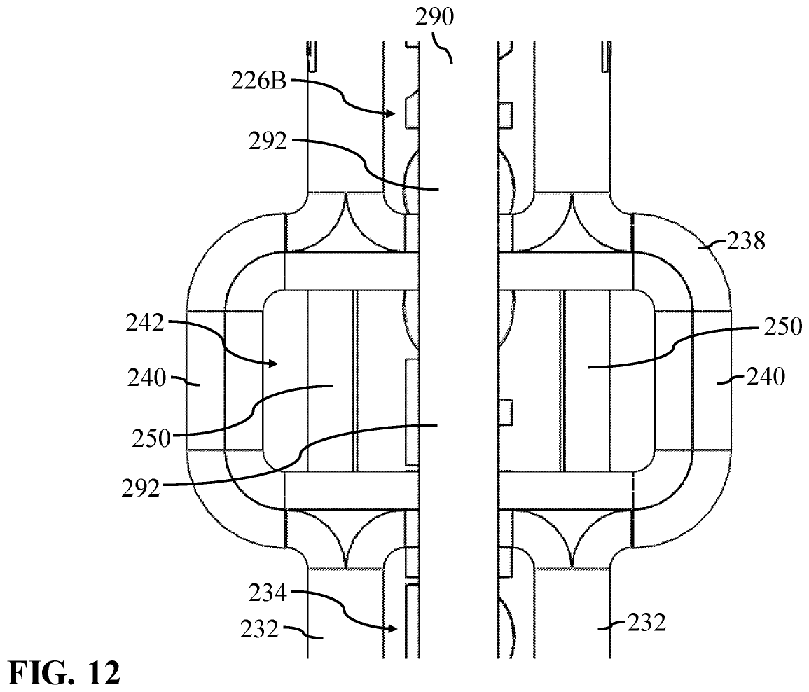

Stem 220 further comprises a handle member 238 disposed between end portions 222 and 230. In an illustrative embodiment, handle member 238 comprises grip portions 240 that extend laterally away from stem 220 relative to arm members 224 and 232, for example, as shown in FIGS. 9 and 12. In some embodiments, handle member 238 comprises an opening 242 through which objects may pass such as, e.g., a user's fingers during carrying.

Stem 220 is attached to base 250 by bracket 236 at a joint 244 that allows stem 220 to rotate about a longitudinal axis of joint 244 to rotate wheel 270 relative to base 250, e.g., for turning personal mobility device 200. In some embodiments, for example, joint 242 comprises a pin and tube or another mechanism about which bracket 236 is configured to rotate to rotate wheel 270 relative to base 250 and turn personal mobility device 200. Joint 244 is attached to base 250 by a flange 246. Stem 220 may be locked in the open configuration and closed configuration where the lock may be released by actuation of a button or other member of personal mobility device 200 to enable transition of stem 220 between the open and folded configurations.

Stem 220 is configured to fold relative to base 250 via the attachment of stem 220 to bracket 236. As seen in FIGS. 9 and 10, stem 220 rotates about bracket 236 via attachment of arm members 232 to bracket 236 at joints 248. As seen in FIGS. 9 and 10, joints 248 are offset relative to an axis of rotation of wheel 270 such that when stem 220 is folded relative to base 250, stem 220 rotates about an axis of joints 248 that is offset relative to the axis of rotation of wheel 270. As an example, the axis of rotation of stem 220 about joints 248 may be parallel to but spaced apart or offset from the axis of rotation of wheel 270. In addition, the axis of rotation of stem 220 about joints 248 may be offset or spaced apart from a platform 252 of base 250 in a direction perpendicular to platform 252. By spacing the axis of rotation of stem 220 apart from the axis of rotation of wheel 270 and the surface of platform 252, stem 220 is able to be folded flat against base 250 when in the folded configuration, e.g., as shown in FIG. 10.

As further shown in FIG. 10, when in the folded configuration, arm members 224 and 232 and handle member 238 are disposed adjacent to or against platform 252 of base 250 with handles 212 rotated into a position that engages a rear end portion 254 of base 250. In the folded configuration, stem 220 and handles 212 inhibit rotation of wheel 270 about the axis of joint 244.

Base 250 comprises platform 252, sometimes referred to as a deck, and an opening 258 that is configured to receive wheel 272. Opening 258 also comprises a mechanism for attaching wheel 272 to base 250 such as, e.g., an axle 174 (FIG. 5) or other mechanism. In some embodiments, base 250 also comprises a fender 260 at least partially covering wheel 272 and a rear taillight 261 (FIG. 9) disposed in a rear end portion 254 of base 250 rearward of opening 258. For example, the rear taillight 261 may be disposed within the uniform profile of rear end portion 254 of base 250.

As shown in FIGS. 9 and 10, opening 226A is configured to at least partially receive wheel 272 and fender 260 when personal mobility device 200 is transitioned to the folded configuration such that stem 220 is able to lay flat against base 250. In some embodiments, wheel 172 may be mounted on a suspension hinge such as, e.g., suspension hinge 176 (FIG. 7).

With reference now to FIG. 13, wheel 270 is available in the folded configuration to engage against a surface 280 such as, e.g., a floor, road, sidewalk, etc. In this configuration, a user may pull personal mobility device 200 using handlebar 210 while allowing wheel 270 to roll on the ground, in a similar manner to pulling a piece of luggage. In this configuration, the user may grasp handle 210 with a portion of the user's hand extending into or through opening 226A of stem 220 for ease of comfort and a stable, centrally aligned pulling position. Alternatively, the user may grasp one or both of handles 212 to pull personal mobility device 200.

With reference again to FIGS. 9-13, carrying mechanism 290 comprises a strap 292 attached to stem 220 at an attachment location 294, e.g., adjacent to headlight 225 or in any other location, and extending down across handle member 238 and opening 242, through opening 234 between arm members 232 and attached to base 250 at an attachment location 298. In some embodiments, strap 292 is permanently affixed to attachment locations 294 and 298. In other embodiments, strap 292 may be removably secured to either or both of attachment locations 294 and 298, for example, using snap-fit, buckles, hook and loop fasteners, or in any other manner.

Carrying mechanism 290 is configured to automatically tighten and loosen depending on the configuration of personal mobility device 200. For example, when personal mobility device 200 is in the open configuration, e.g., as shown in FIG. 9, strap 292 is pulled taught against stem 220 from attachment location 292 across handle member 238 while when personal mobility device 200 is in the folded configuration, e.g., as shown in FIG. 10, strap 292 is automatically loosened such that a user may use strap 292 to carry personal mobility device 200, e.g., by hand, over a shoulder, across the back, or in any other manner. A user may also or alternatively hang personal mobility device 200, e.g., from a hook, banister or in another location or use strap 292 for any other purpose. In some embodiments, stem 220 may comprise a smooth surface or padding positioned under strap 292 or on arm members 224 and 234 or handle member 238 that is configured to engaged against the user when the user carries personal mobility device 200 using strap 292, e.g., on the user's back or in another manner, to provide comfortable carrying to the user. In an illustrative embodiment, a central portion 296 of strap 292 is positioned above a center of balance of personal mobility device 200 when personal mobility device 200 is in the folded configuration such that personal mobility device 200 is balanced when being carried by the user using strap 292.

Strap 292 is automatically loosened and tightened by the transition between the open configuration of FIG. 9 and the folded configuration of FIG. 10. For example, when stem 220 is transitioned from the open configuration to the folded configuration, e.g., by folding stem 220 toward base 250 about joints 248, the tension on strap 292 caused by stem 220 is loosened by moving handle member 238 and opening 234 closer to attachment location 298, e.g., as shown in FIG. 10. Similarly, when stem 220 is transitioned from the folded configuration to the open configuration, the tension on strap 292 is increased by movement of handle member 238 and opening 234 away from attachment location 292 such that strap 292 is pulled taught against handle member 238. By increasing the tension on strap 292, strap 292 is engaged against a front of stem 220 and kept out of the way to inhibit strap 292 from being caught on any objects while personal mobility device 200 is in use. In this manner, a user need only transition personal mobility device 200 between the folded configuration and the open configuration to either make use of strap 292 or to put strap 292 away for operation of personal mobility device 200 without requiring the user to take any additional steps to otherwise manipulate, attach, or access strap 292. This enables the user to more quickly transition between using and carrying personal mobility device 200.

In addition to strap 292, a user may also carry personal mobility device 200 by grip portions 240 of handle member 238 when personal mobility device 200 is in the folded configuration. As seen in FIG. 12, for example, when personal mobility device 200 is in the folded configuration, grip portions 240 of handle member 238 and opening 242 extend beyond the sides of base 250 such that a user is able to grasp one or both of grip portions 240 without their hand contacting base 250. In an illustrative embodiment, handle member 238 is located at a center of balance of personal mobility device 200 when personal mobility device 200 is in the folded configuration such that a user grasping one of grip portions 240 may easily carry personal mobility device 200 at the center of balance which may inhibit additional strain on the user's hands or wrists.

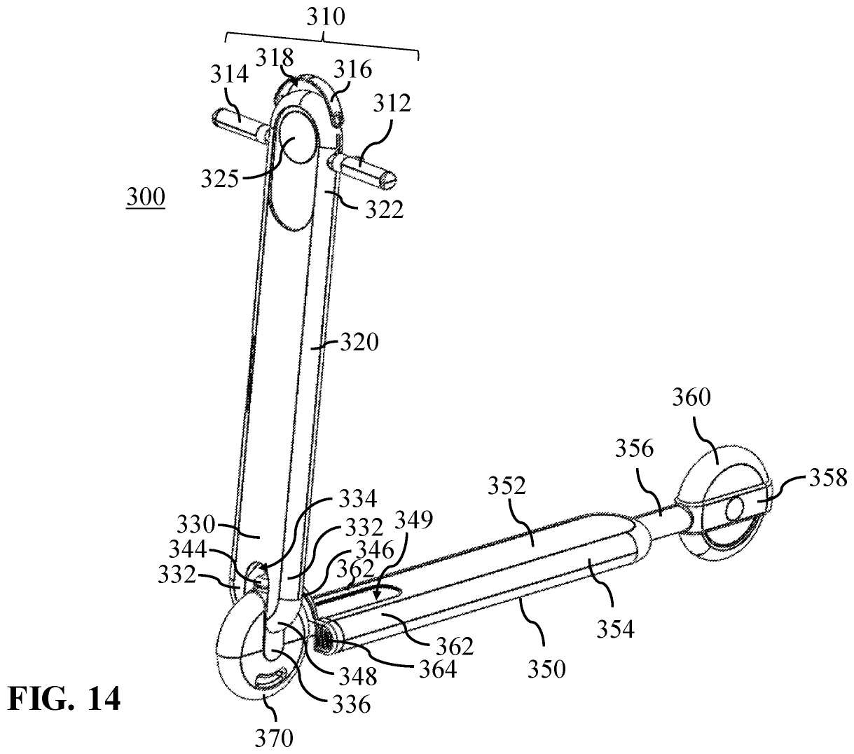

With reference to FIGS. 14-26, example embodiments of a personal mobility device 300 are disclosed. Personal mobility device 300 is configured to provide a user with personal mobility, e.g., personal transportation from place to place. In an illustrative embodiment, personal mobility device 300 comprises a scooter, e.g., as shown in FIG. 14. In other embodiments, personal mobility device 300 may comprise other devices that may be used to transport a user including bicycles, skateboards, unicycles, hoverboards, tricycles, 3-wheels, ride-ons, strollers, carts or any other personal mobility device. In some embodiments, personal mobility device 300 comprises a user powered personal mobility device, e.g., movement of the personal mobility device is caused by physical effort of the user such as by kicking, dragging, running, pushing or otherwise driving a movement of personal mobility device. In some embodiments, personal mobility device 300 comprises a powered personal mobility device, e.g., comprising an electric or other type of motor that is configured to cause movement of personal mobility device 300 by driving one or more of the wheels of personal mobility device 300 or in any other manner.

In some embodiments, personal mobility device 300 may comprise some features or components that are similar to those found on one or more of personal mobility devices 100, 200, 400, 500 and 600. Where possible, similar features and components will be referred to with similar reference numbers. In addition, any of the features or features described herein with respect to personal mobility devices 100, 200, 400, 500 and 600 may be utilized in personal mobility device 300 and vice versa in various embodiments without departing from the scope of the present disclosure.

Personal mobility device 300 comprises a handlebar 310, a stem 320, a base 350, a wheel 370, a wheel 372, a wheel cover mechanism 380 and a carrying mechanism 390. In other embodiments, other configurations may alternatively be utilized including, e.g., an alternate handlebar 310, stem 320, base 350, wheels 370, wheel 372, cover mechanism 380, carrying mechanism 390 or any other alternative components or configurations including those shown in the other embodiments provided herein.

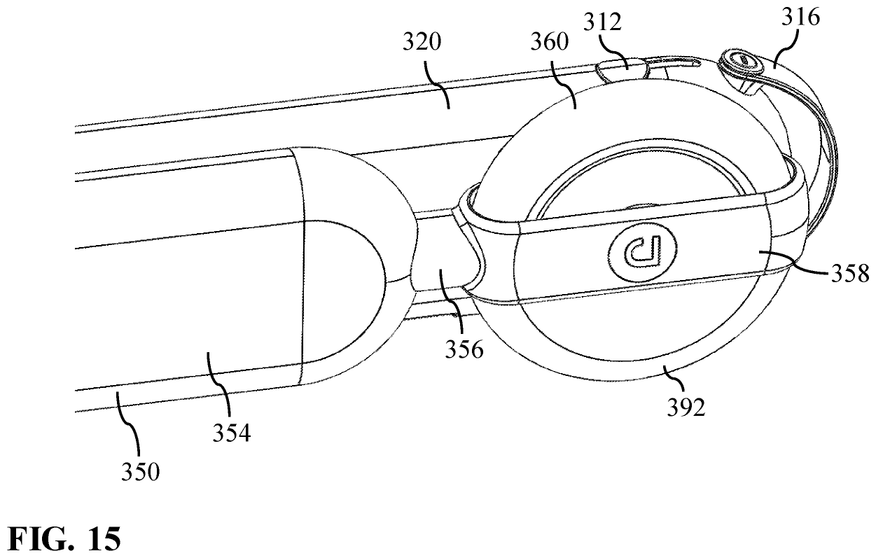

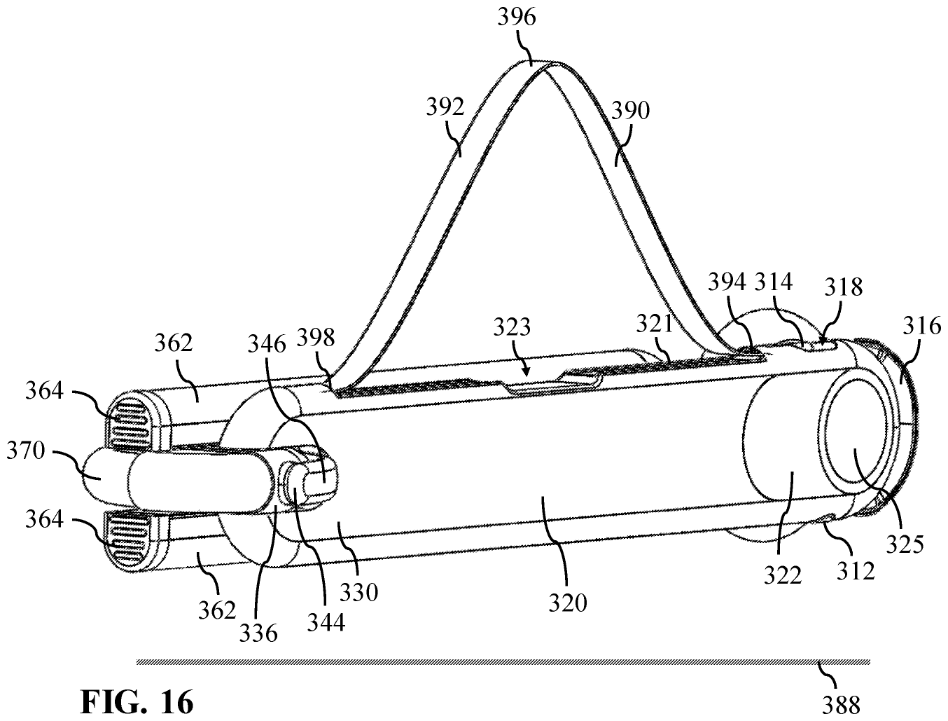

Handlebar 310 comprises handles 312, 314 and 316 at an end portion 322 of stem 320. Handles 312 and 314 are configured to collapse from an extended position, also referred to as a first position, such as shown in FIG. 14 to a collapsed position, also referred to as a second position, such as shown in FIGS. 15 and 16 where handles 312 and 314 are received within end portion 322 of stem 320. In some embodiments, for example, one or both of handles 312 and 314 may slide linearly along end portion 322 of stem 320 in a longitudinal direction of stem 320 such that handles 312 and 314 are displaced relative to one another in the longitudinal direction before insertion into end portion 322 stem 320, for example, as shown in FIGS. 15 and 16. In an embodiment, for example, handle 314 may slide longitudinally along a slot 318 (FIG. 16) while handle 312 may remain fixed in place such that handle 314 is offset relative to handle 312 in the longitudinal direction of stem 320. Handles 312 and 314 may then be inserted into end portion 322 of stem 320 adjacent to each other such that they are level with or below the side surfaces of stem 320 as shown in FIGS. 15 and 16. In some embodiments, a button or another component may be utilized to release one or both of handles 312 and 314 or to unlock one or both of handles 312 and 314 for insertion into stem 320.

Handle 316 is attached to end portion 322 of stem 320 and defines an opening 318 between handle 316 and end portion 322 of stem 320.

Stem 320 further comprises a headlight 325, e.g., battery powered or powered in another manner, attached to end portion 322 that is configured to illuminate an area in front of personal mobility device 300.

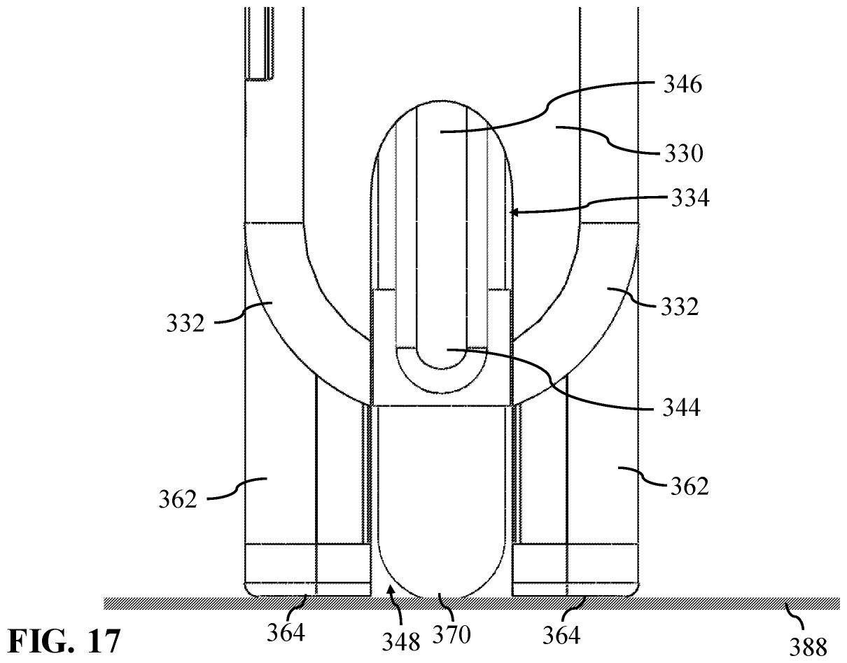

Stem 320 also comprises an end portion 330 opposite end portion 322. End portion 330 comprises arm members 332 that define an opening 334 therebetween. Arm members 332 are attached to a bracket 336 that is attached to wheel 370. Bracket 336 is configured to engage with wheel 370 to enable rotation of wheel 370 about a central axis of wheel, e.g., using an axle or another component, during movement of personal mobility device 300 across a surface 388 (FIG. 17) such as a floor, road, sidewalk, etc.

Stem 320 is attached to base 350 by bracket 336 at a joint 344 that allows stem 320 to rotate about a longitudinal axis of joint 344 to rotate wheel 370 relative to base 350, e.g., for turning personal mobility device 300. In some embodiments, for example, joint 344 comprises a pin and tube or another mechanism about which bracket 336 is configured to rotate to rotate wheel 370 relative to base 350 and turn personal mobility device 300. Joint 344 is attached to base 350 by a flange 346.

Stem 320 is configured to fold relative to base 350 via the attachment of stem 320 to bracket 336. As seen in FIGS. 14 and 16, stem 320 rotates about bracket 336 via attachment of arm members 332 to bracket 336 at joints 348. In some embodiments, joints 348 are offset relative to an axis of rotation of wheel 370 such that when stem 320 is folded relative to base 350, stem 320 rotates about an axis of joints 348 that is offset relative to the axis of rotation of wheel 370. As an example, the axis of rotation of stem 320 about joints 348 may be parallel to but spaced apart or offset from the axis of rotation of wheel 370. In addition, the axis of rotation of stem 320 about joints 348 may be offset or spaced apart from a platform 352 of base 350 in a direction perpendicular to platform 352. By spacing the axis of rotation of stem 320 apart from the axis of rotation of wheel 370 and the surface of platform 352, stem 320 is able to be folded flat against base 350 when in the folded configuration, e.g., as shown in FIGS. 15 and 16. Stem 320 may be locked in the open configuration and closed configuration where the lock may be released by actuation of a button or other member of personal mobility device 300 to enable transition of stem 320 between the open and folded configurations.

In some embodiments, flange 346 may also be retracted longitudinally into base 350 along a slot 349 to slide wheel 370 and stem 320 rearward into base 350. As shown in FIGS. 16 and 17, for example, retraction of flange 346 into slot 349 may cause wheel 370 to be retracted between arms 362 of base 350 to expose standing surfaces 364 of base 350 such that personal mobility device 300 may stand on standing surfaces 364 and be inhibited from falling over in a similar manner to standing surfaces 164 of personal mobility device 100.

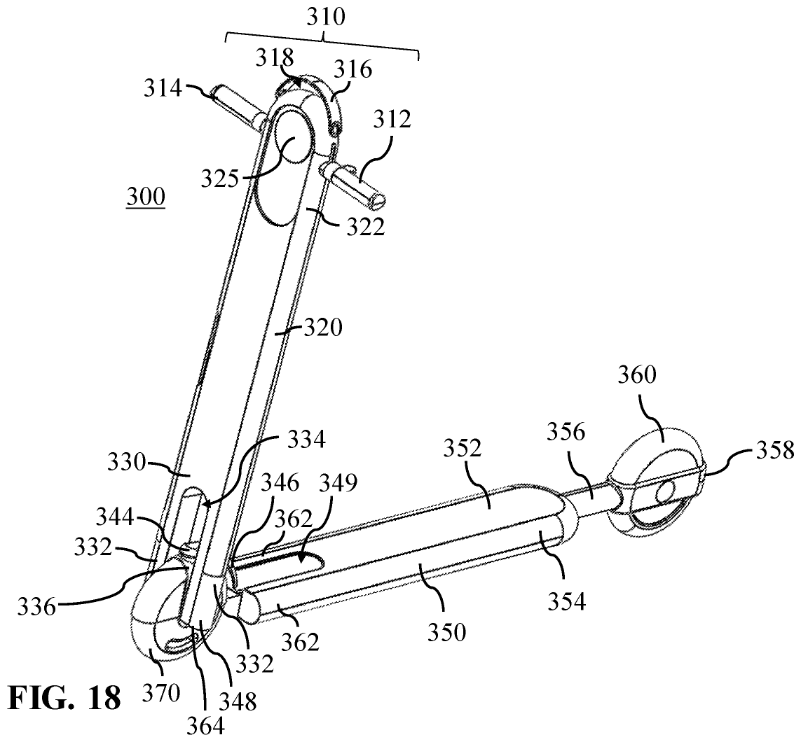

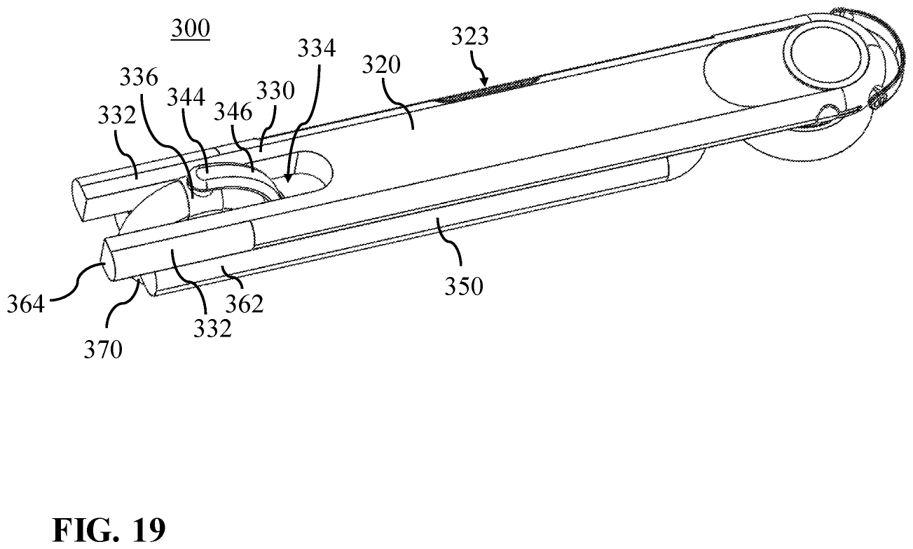

With reference to FIGS. 18 and 19, in some embodiments, arms 332 of stem 320 may comprise standing surfaces 364. In this embodiment, flange 346 may be retracted longitudinally into base 350 along slot 349 to slide wheel 370 rearward into base 350 while wheel 370 may also be retracted longitudinally into opening 334 of stem 320. As shown in FIGS. 18 and 19, for example, retraction of flange 346 into slot 349 of base 350 and wheel 370 into opening 334 of stem 320 may cause wheel 370 to be retracted between arms 332 of stem 320 to expose standing surfaces 364 of stem 320 such that personal mobility device 300 may stand on standing surfaces 364 and be inhibited from falling over.

Base 350 comprises platform 352, sometimes referred to as a deck, a body 354 and a distal portion 356 extending distally from body 354. In some embodiments, distal portion 356 may have an elongated or tubular shape that defines a width or diameter that is smaller than the body 354. Distal portion 356 comprises a mounting bracket 358 that is attached to wheel 372, e.g., using an axle or other mechanism. Distal portion 356 also comprises a fender 360 at least partially covering wheel 372. Distal portion 356 may also comprise a rear taillight similar to rear taillights 161 (FIGS. 5) and 261 (FIG. 9) in some embodiments.

As shown in FIGS. 15 and 16, distal portion 356 is configured to rotate about a longitudinal axis of distal portion 356 relative to body 354 to rotate wheel 372. For example, wheel 372 may be rotated 90 degrees in some embodiments, e.g., as shown in FIGS. 15 and 16, such that when personal mobility device 300 is in the folded configuration, wheel 372 is flat relative to stem 320 and body 354. In some embodiments, a user may manually rotate wheel 372. In other embodiments, wheel 372 may be rotated as part of the transition between the open configuration and the folded configuration using a rotating mechanism such as, e.g., cables, wires, pulleys, gears, or any other mechanism that automatically rotates wheel 372 when stem 320 is folded toward base 350.

In some embodiments, distal portion 356 is also configured for translation into and out of body 354. For example, in the open configuration, distal portion 356 may be extended from body 354 to provide a longer base 350 for riding stability. In the folded configuration, distal portion 356 may be at least partially retracted into body 354 to move wheel 372 closer to body 354 for more compact storage of personal mobility device 300. Extension and retraction of distal portion 356 may be manual by the user or may be automatic, e.g., using a mechanism such as, e.g., cables, wires, pulleys, gears, or any other mechanism that automatically translates distal portion 356 into and out of body 354 when stem 320 is folded toward base 350.

With reference again to FIG. 16, carrying mechanism 390 comprises a strap 392 attached to stem 320 at an attachment location 394, e.g., on a side surface 321 of stem 320 near end portion 322 or in any other location, and extending down across side surface 321 of stem 320 to an attachment location 398 on stem 320 near end portion 330. In some embodiments, strap 392 is permanently affixed to attachment locations 394 and 398. In other embodiments, strap 392 may be removably secured to either or both of attachment locations 394 and 398, for example, using snap-fit, buckles, hook and loop fasteners, or in any other manner. Strap 392 may alternatively be attached to any other portion of personal mobility device 300 in other embodiments.

Carrying mechanism 390 is configured to tighten and loosen strap 392 through an action by user. For example, strap 392 may be tensioned tight against side surface 321 of stem 320 during use of personal mobility device 300 by a tensioning mechanism, e.g., by a spring-loaded wrapping mechanism or another mechanism. One example mechanism may be that used for tensioning strap 392 may be that used for seatbelts in automobiles. When the user wants to use strap 392 to carry personal mobility device 300, the user may pull on strap 392 to loosen strap 392 against the tensioning mechanism. In some embodiments, strap 392 may be ratcheted where, for example, pulling on strap 392 by user may engage ratchet segments such that the tensioning mechanism along with the ratchet holds strap 392 at the desired length. In other embodiments, strap 392 may be configured to be pulled to a certain length or level of looseness by user, e.g., as shown in FIG. 16. The user may carry personal mobility device 300 on a shoulder, across a back, or in another manner.

Side surface 321 or any other portion of stem 320 may have a smooth surface, a padded surface, or both to facilitate a comfortable carry of personal mobility device 300 by the user when using strap 392. In an illustrative embodiment, a central portion 396 of strap 392 is positioned above a center of balance of personal mobility device 300 when strap 392 is tensioned or loosened such that personal mobility device 300 is balanced when being carried by the user using strap 392.

In some embodiments, stem 320 further comprises a channel 323 under the center portion 396 of strap 392 that is configured to allow a user to grasp strap 392 even when strap 392 is fully tensioned against side surface 321 by the tensioning mechanism. For example, the user may insert a portion of their hand through channel 323 under strap 392 either to pull on strap 392 to loosen strap 392 or to carry personal mobility device 300 using strap 392 when strap 392 is fully tensioned.

In some embodiments, a release button or other mechanism may be utilized to enable strap 392 to be loosened by the user, to cause an automatic retraction of the strap 392 from a loose configuration such as shown in FIG. 16 to a tensioned configuration against side surface 321 or for any other purpose. In some embodiments, transitioning personal mobility device 300 to the folded configuration may actuate or activate the release button or other mechanism such that the tensioning mechanism is released to allow the user to pull strap 392 away from side surface 321 for carrying. In some embodiments, transitioning personal mobility device 300 from the folded configuration to the open configuration may release the button or other mechanism to allow tensioning mechanism to engage strap 392 such that strap 392 is automatically tensioned and retracted against side surface 321.

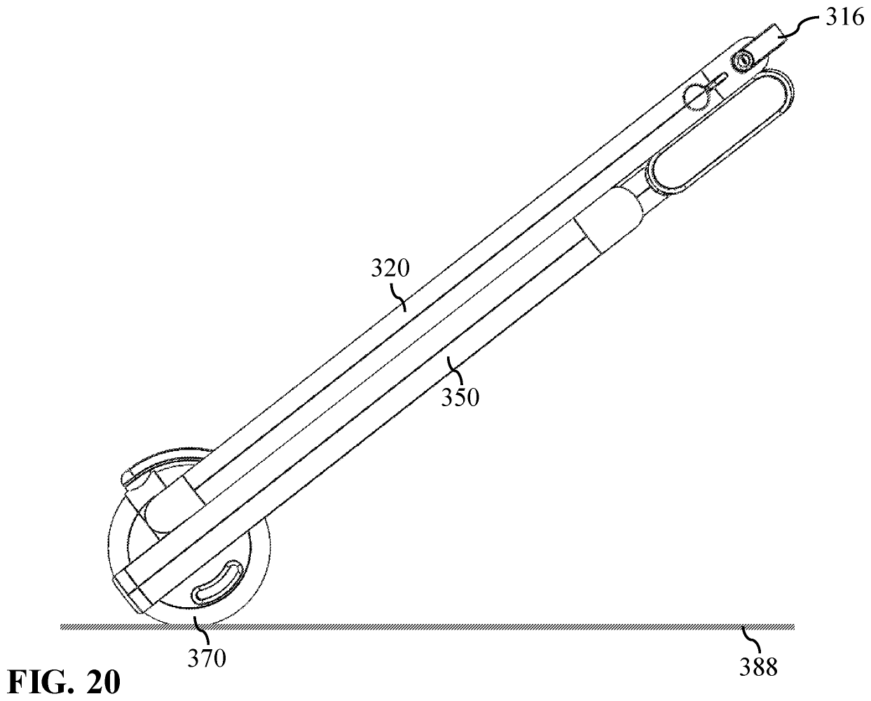

With reference now to FIG. 20, wheel 370 is available in the folded configuration to engage against a surface 388 such as, e.g., a floor, road, sidewalk, etc. In this configuration, a user may pull personal mobility device 300 using handle 316 while allowing wheel 370 to roll on the ground, in a similar manner to pulling a piece of luggage. In this configuration, the user may grasp handle 316 with a portion of the user's hand extending into or through opening 318 between handle 316 and distal portion 322 of stem 320 for ease of comfort and a stable, centrally aligned pulling position.

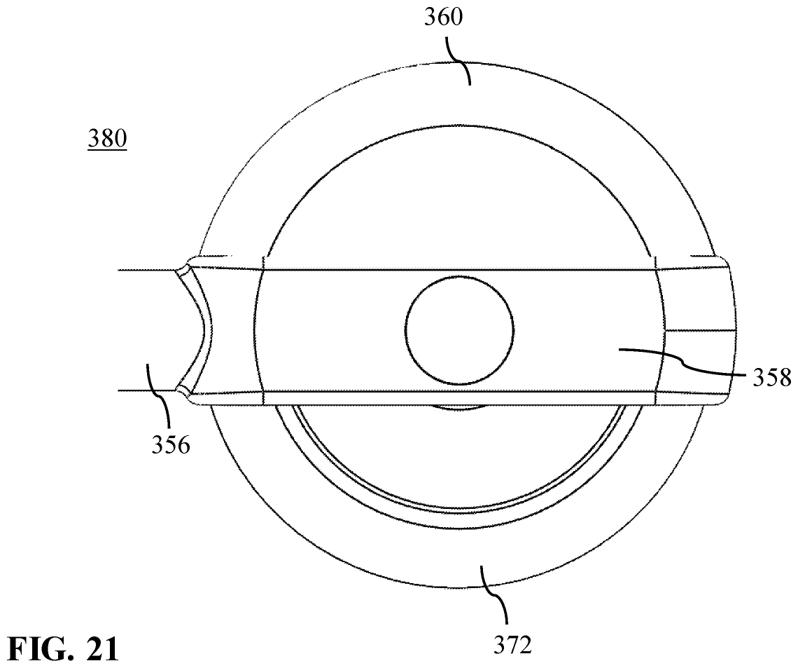

With reference again to FIGS. 21-26, an embodiment of wheel cover mechanism 380 will now be described. Wheel cover mechanism 380 is integrated into mounting bracket 358 and fender 360 and is configured to cover wheel 372 when personal mobility device 300 is not in use. In some embodiments, wheel 370 may also or alternatively comprise a wheel cover mechanism 380.

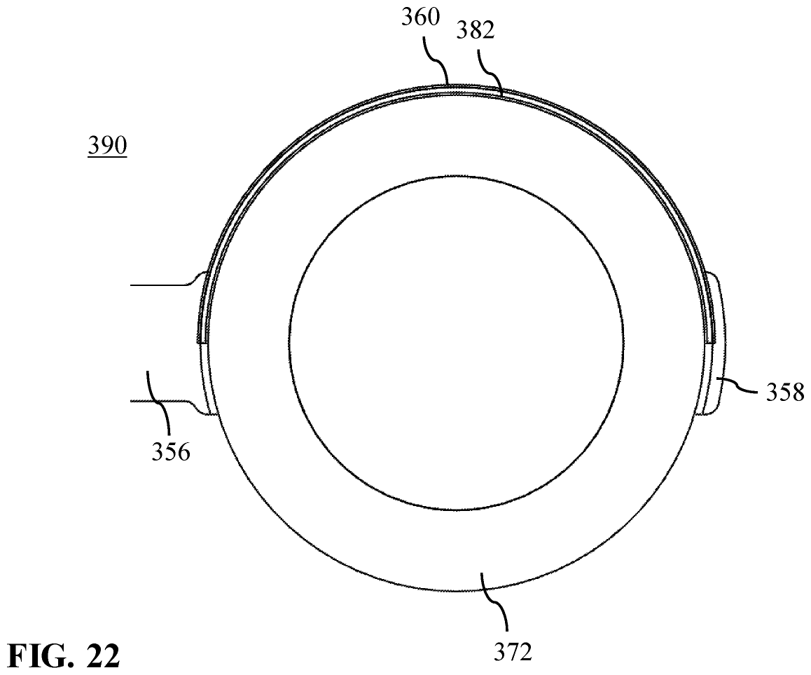

With reference to FIGS. 21 and 22, wheel cover mechanism 380 comprises a cover 382 nested within fender 360 in a retracted position. For example, cover 382 may be concentrically nested within fender 360 and define a radius smaller than that of fender 360 relative to an axis of wheel 372. In some embodiments, as seen from the outside, e.g., as shown in FIG. 21, cover 382 may not be visible relative to fender 360 and bracket 358. In other embodiments, a portion of cover 382 may alternatively be visible relative to fender 360 and bracket 358 when in the retracted position.

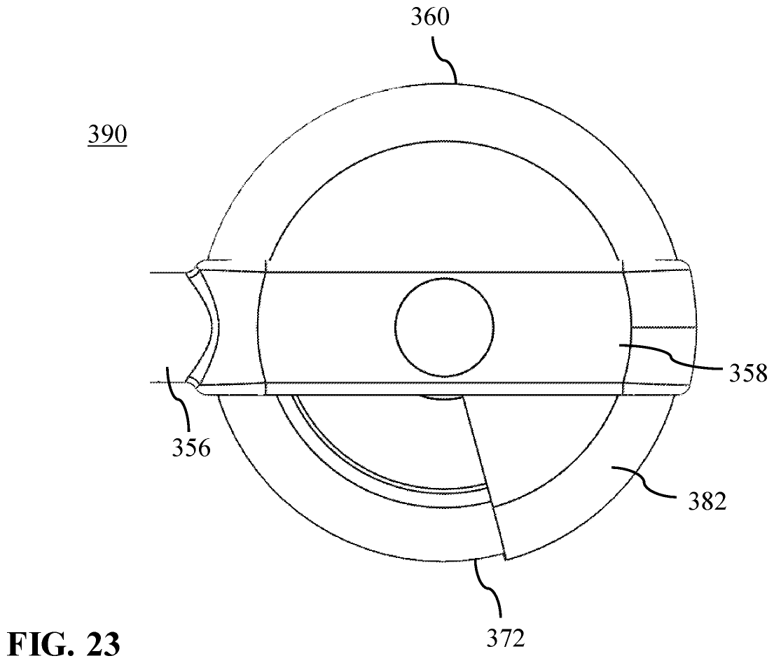

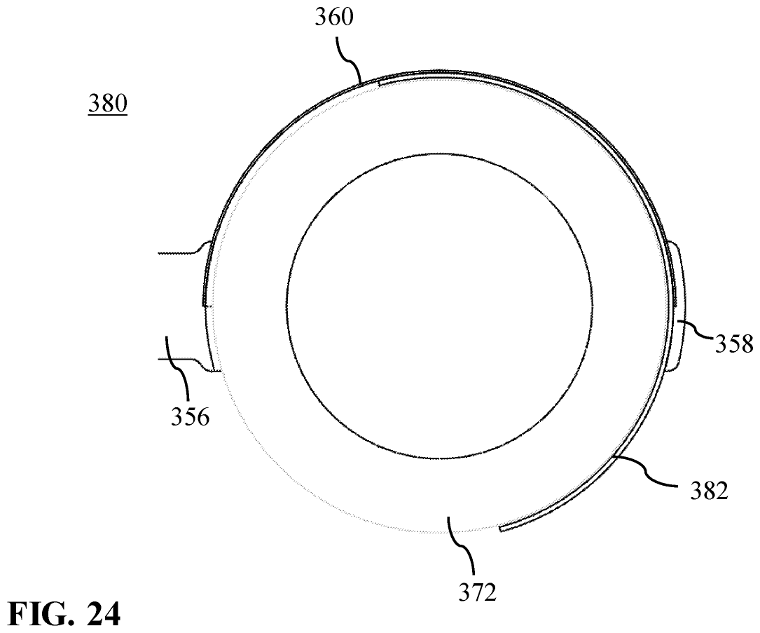

With reference to FIGS. 23 and 24, cover 382 is shown in a partially extended position covering a portion of wheel 372. For example, cover 382 may be rotated about a central axis of wheel to release cover 382 from within fender 360 and bracket 358.

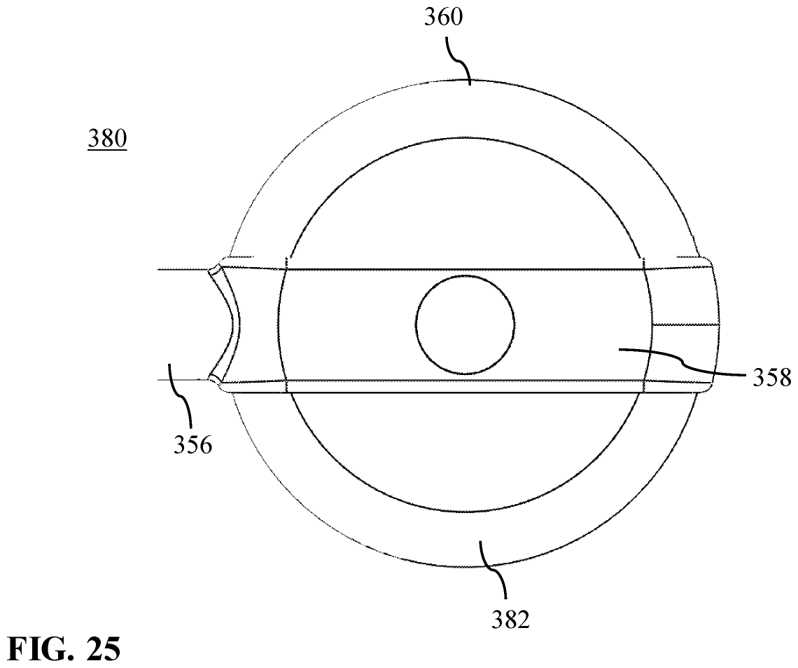

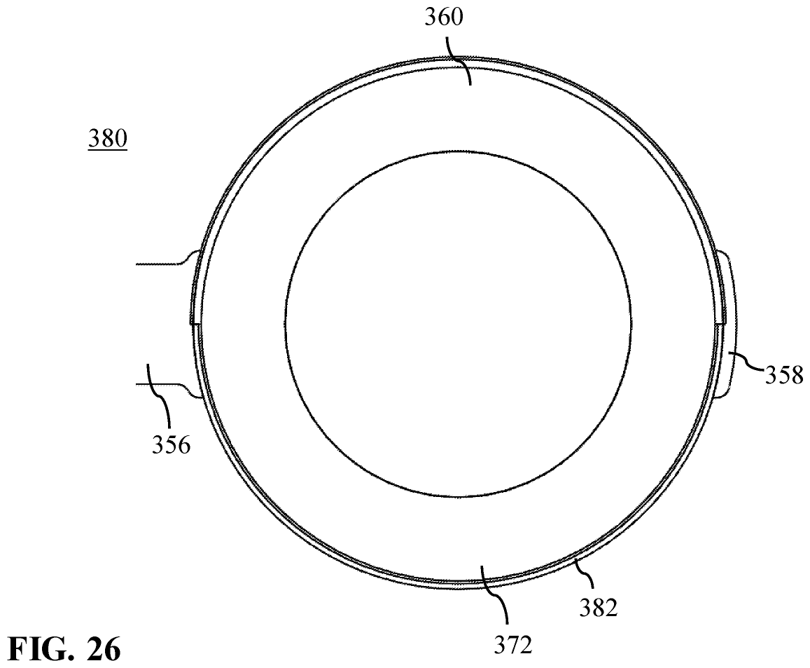

With reference to FIGS. 25 and 26, cover 382 is shown in a fully extended position to cover wheel 372. For example, cover 382 may be further rotated about a central axis of wheel such that wheel 372 is fully covered by cover 382, bracket 358 and fender 360.

In some embodiments, cover 382 may be spring loaded such that an actuation of a button or other component may cause cover 382 to rotate out of fender 360 and bracket 358 from the retracted position to the fully extended position or partially extended position. In some embodiments, cover 382 may also or alternatively comprise a structural component such as, e.g., a knob, flange, lip or other structure that a user may grasp or otherwise articulate to cause rotation of cover 382 between one or more of the retracted position, partially extended position and fully extended position. In some embodiments, cover 382 may be automatically transitioned from retracted position to one or both of the partially extended position and fully extended position during transition of personal mobility device 300 from the open configuration to the folded configuration. For example, cables, wires or other components may engage against a spring loading mechanism such that as personal mobility device 300 is transitioned from the open configuration to the folded configuration, the spring loading mechanism is released to drive cover 382 out of fender 360 to cover wheel 372. In some embodiments, cover 382 may be released in conjunction with the rotation of wheel 372, the retraction of end portion 356 or in conjunction with any other mechanism associated with transitioning personal mobility device 300 from the open configuration to the folded configuration. In some embodiments, cover 382 may also be automatically retracted into fender 360 during the transition of personal mobility device 300 from the folded configuration to the open configuration, e.g., using any of the mechanisms described above.

While wheel cover mechanism 382 is described with reference to wheel 372 of personal mobility device 300 in the embodiment of FIGS. 14-26, in other embodiments, wheel cover mechanism 382 may also or alternatively be utilized with any of the wheels of any other embodiment including, e.g., personal mobility device 100, personal mobility device 200, personal mobility device 400, personal mobility device 500 and personal mobility device 600.

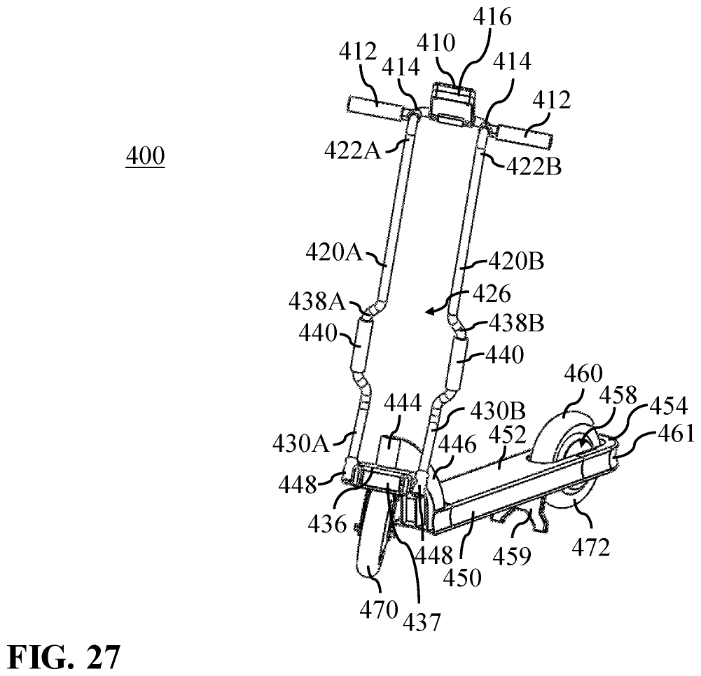

With reference to FIGS. 27-41, an example embodiment of a personal mobility device 400 is disclosed. Personal mobility device 400 is configured to provide a user with personal mobility, e.g., personal transportation from place to place. In an illustrative embodiment, personal mobility device 400 comprises a scooter, e.g., as shown in FIG. 27. In other embodiments, personal mobility device 400 may comprise other devices that may be used to transport a user including bicycles, skateboards, unicycles, hoverboards, tricycles, 3-wheels, ride-ons, strollers, carts or any other personal mobility device. In some embodiments, personal mobility device 400 comprises a user powered personal mobility device, e.g., movement of the personal mobility device is caused by physical effort of the user such as by kicking, dragging, running, pushing or otherwise driving a movement of personal mobility device. In some embodiments, personal mobility device 400 comprises a powered personal mobility device, e.g., comprising an electric or other type of motor that is configured to cause movement of personal mobility device 400 by driving one or more of the wheels of personal mobility device 400 or in any other manner.

In some embodiments, personal mobility device 400 may comprise some features or components that are similar to those found on one or more of personal mobility devices 100, 200, 300, 500 and 600. Where possible, similar features and components will be referred to with similar reference numbers. In addition, any of the features or features described herein with respect to personal mobility devices 100, 200, 300, 500 and 600 may be utilized in personal mobility device 400 and vice versa in various embodiments without departing from the scope of the present disclosure.

Personal mobility device 400 comprises a handlebar 410, a stem 420, a base 450, a wheel 470, a wheel 472 and a carrying mechanism 490. In other embodiments, other configurations may alternatively be utilized including, e.g., an alternate handlebar 410, stem 420, base 450, wheels 470 and 472, carrying mechanism 490 or any other alternative components or configurations including those shown in the other embodiments provided herein.

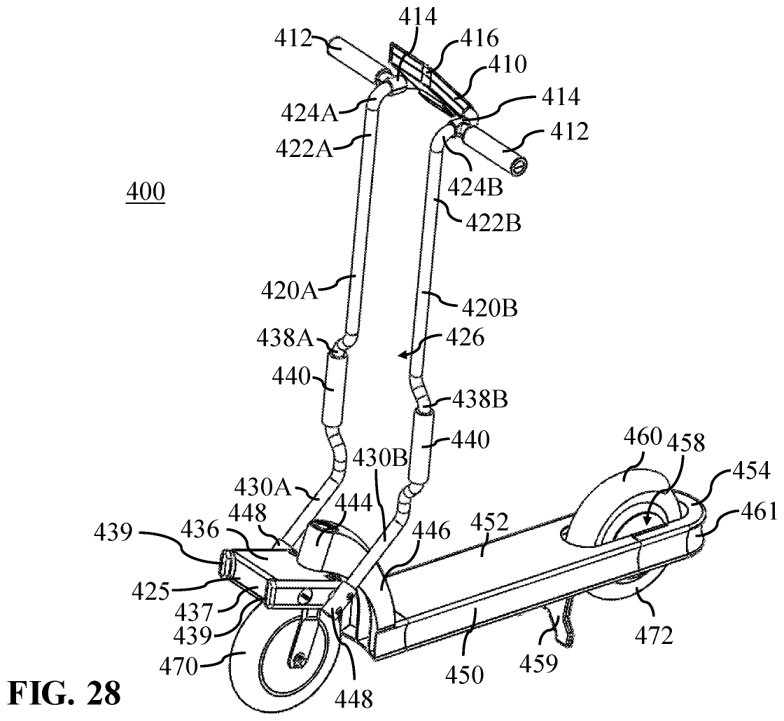

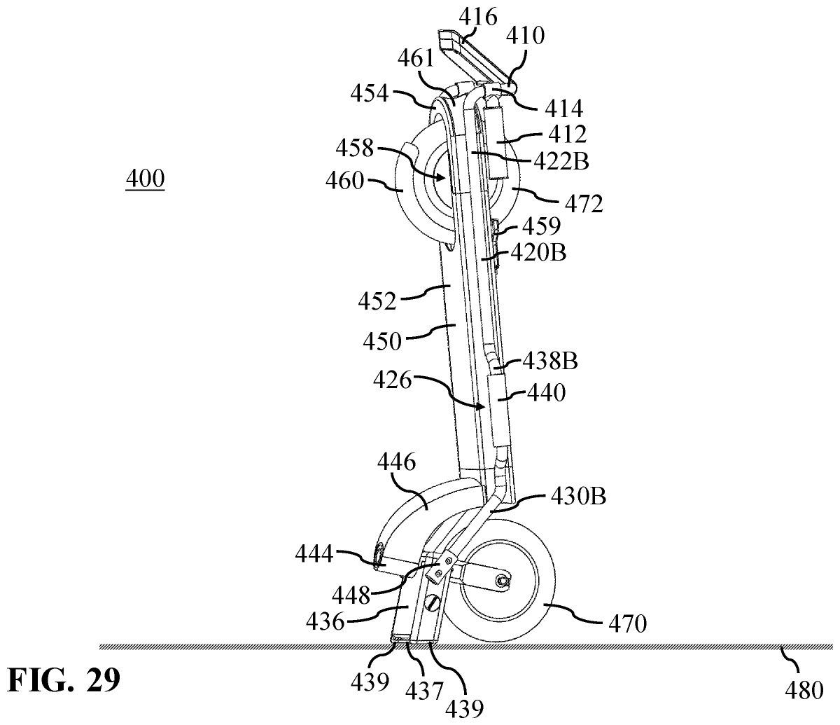

Handlebar 410 comprises handles 412 that are configured to collapse or fold from an extended position, also referred to as a first position, such as shown in FIGS. 27 and 28 to a collapsed or folded position, also referred to as a second position, such as shown in FIGS. 29-37. Handles 412 may collapse or fold, for example, by bending, twisting, rotating, or in any other manner. In some embodiments, for example, handles 412 are attached to handlebar 410 by folding mechanisms 414 such as shown in FIGS. 27 and 29 where, for example, handles 412 may be configured to rotate with folding mechanisms 414 from the first position (FIG. 27) to the second position (FIG. 29). In some embodiments, folding mechanisms 414 may rotate handles 412 from the first position to the second position such that handles 412 are disposed adjacent to respective stem members 420A and 420B. For example, in some embodiments, handles 412 may be folded parallel to the respective stem members 420A and 420B. In some embodiments, handles 412 may be folded parallel to the base 450 and platform 452. In other embodiments, any other angle may be utilized for handles 412.

In some embodiments, handlebar 410 also comprises a tray 416 that is configured to hold a device such as, e.g., a mobile phone, tablet, or display screen that may be utilized by a user of personal mobility device 400.

Handlebar 410 is attached to end portions 422A and 422B of stem 420. In some embodiments, for example, end portions 422A and 422B may have a bent portions 424A and 424B (FIGS. 28 and 29), e.g., at a 90-degree angle or another angle to end portions 422A and 422B of stem 420, in proximity to handles 412 and handlebar 410. In some embodiments, handlebar 410 is integrated as part of stem 420 with handles 412 being attached to stem members 420A and 420B adjacent bent portions 424A and 424B via folding mechanisms 414. As an example, in an embodiment, folding mechanism 414 for each handle 412 is rotatable about bent portions 424A and 424B to transition handles 412 from the first position (FIGS. 27 and 28) to the second position (FIGS. 29-37).

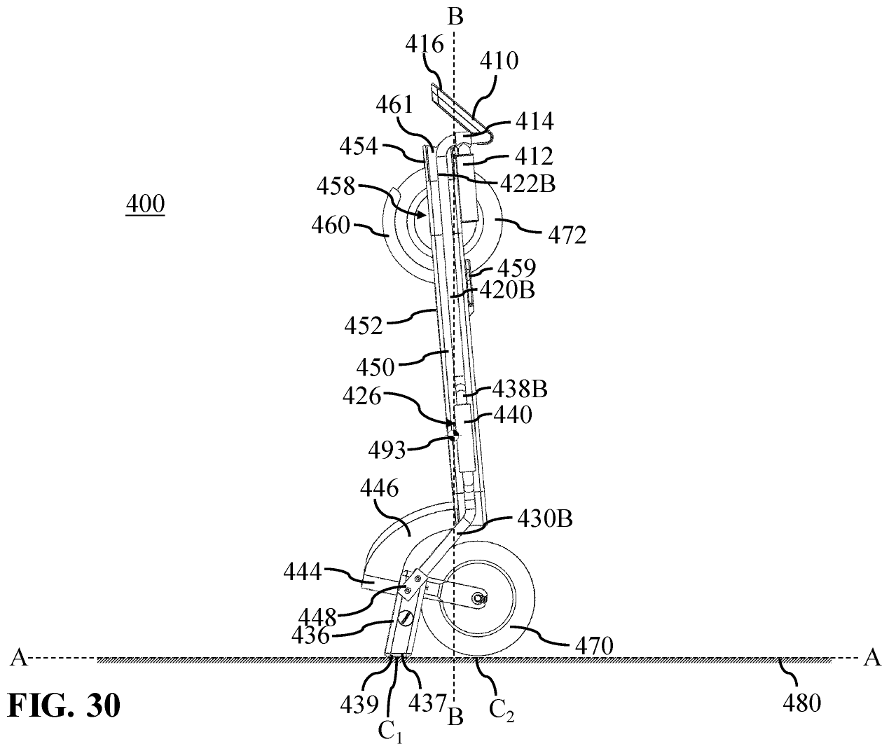

Stem 420 also comprise end portions 430A and 430B opposite end portions 422A and 422B. End portions 430A and 430B are attached to a bracket 436 that is attached to wheel 470. Bracket 436 is configured to engage with wheel 470 to enable rotation of wheel 470 about a central axis of wheel, e.g., using an axle or another component, during movement of personal mobility device 400 across a surface 480 (FIGS. 29, 30 and 41) such as a floor, road, sidewalk, etc. In some embodiments, bracket 436 comprises a stand 437 extending toward a front of personal mobility device 400 that is configured, in conjunction with wheel 470, for engagement against a surface 480 to stand up personal mobility device 400 and inhibit personal mobility device 400 from falling when in the folded configuration, e.g., as shown in FIGS. 29 and 30. The spacing between wheel 470 and stand 437 when wheel 470 and stand 437 are engaged against surface 480 provides stability to personal mobility device 400 when standing and may be sized as needed to provide the desired level of stability. In some embodiments, stand 437 comprises feet 439 that are configured to engage against surface 480. In an illustrative embodiment, the attachment of stem 420 to bracket 436 is offset from the axis of rotation of wheel 470. In some embodiments, stand 437 comprises a headlight 425, e.g., battery powered or powered in another manner, that is configured to illuminate an area in front of personal mobility device 400.

With reference to FIG. 30, in an embodiment, center of balance 493 of personal mobility device 400 is located vertically between the portion of stand 437 that contacts surface 480 and the portion of wheel 470 that contacts surface 480. As an example, stand 437 and wheel 470 together define a plane of contact A-A, e.g., similar to surface 480 in FIG. 30, where an axis B-B extending perpendicular to the plane of contact A-A through center of balance 493 is disposed between the locations C₁and C₂ where stand 437 and wheel 470, respectively, contact the plane of contact A-A. By locating the center of balance 493 between the contact locations C₁and C₂, a more stable standing of personal mobility device 400 may be achieved.

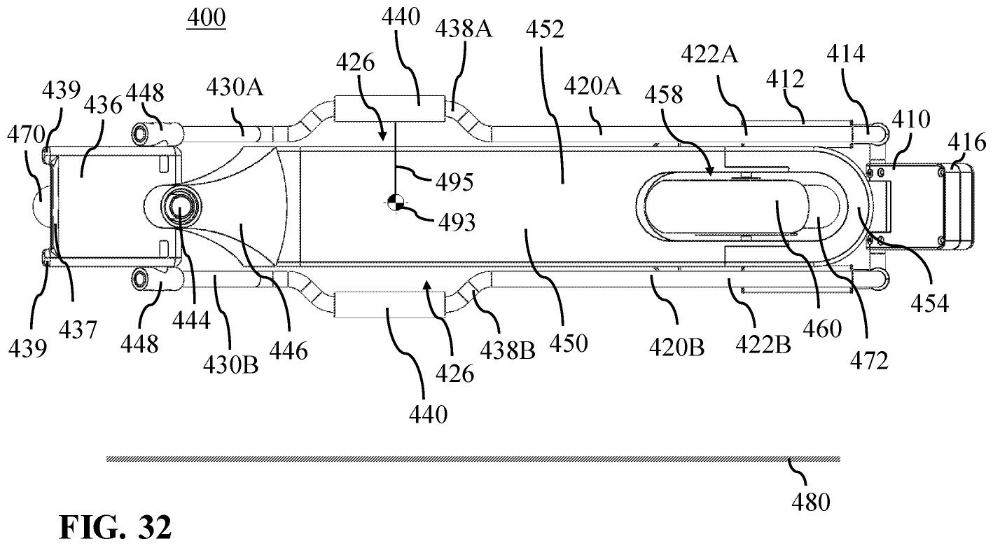

Stem members 420A and 420B further comprise handle members 438A and 438B disposed between end portions 422A and 430A and 422B and 430B, respectively. In an illustrative embodiment, handle members 438A and 438B comprise grip portions 440 that are laterally offset relative to the rest of stem 420, for example, as shown in FIGS. 27 and 32. In some embodiments, stem 420 comprises an opening 426 between stem members 420A and 420B where the opening 426 is wider adjacent to handle members 438A and 438B to enable objects, e.g., a user's fingers during carrying, to pass through opening 426 adjacent handle members 438A and 438B when personal mobility device 400 is in the folded configuration.

Stem 420 is attached to base 450 by bracket 436 at a joint 444 that allows stem 420 to rotate about a longitudinal axis of joint 444 to rotate wheel 470 relative to base 450, e.g., for turning personal mobility device 400. In some embodiments, for example, joint 444 comprises a pin and tube or another mechanism about which bracket 436 is configured to rotate to rotate wheel 470 relative to base 450 and turn personal mobility device 400. Joint 444 is attached to base 450 by a flange 446.

Stem 420 is configured to fold relative to base 450 via the attachment of stem 420 to bracket 436. As seen in FIGS. 27 and 29, stem 420 rotates about bracket 436 via attachment of stem members 420A and 420B to bracket 436 at joints 448. As seen in FIGS. 27 and 29, joints 448 are offset relative to an axis of rotation of wheel 470 such that when stem 420 is folded relative to base 450, stem 420 rotates about an axis of joints 448 that is offset relative to the axis of rotation of wheel 470. As an example, the axis of rotation of stem 420 about joints 448 may be parallel to but spaced apart or offset from the axis of rotation of wheel 470. In addition, the axis of rotation of stem 420 about joints 448 may be offset or spaced apart from a platform 452 of base 450 in a direction perpendicular to platform 452. Stem 420 may be locked in the open configuration and closed configuration where the lock may be released by actuation of a button or other member of personal mobility device 400 to enable transition of stem 420 between the open and folded configurations.

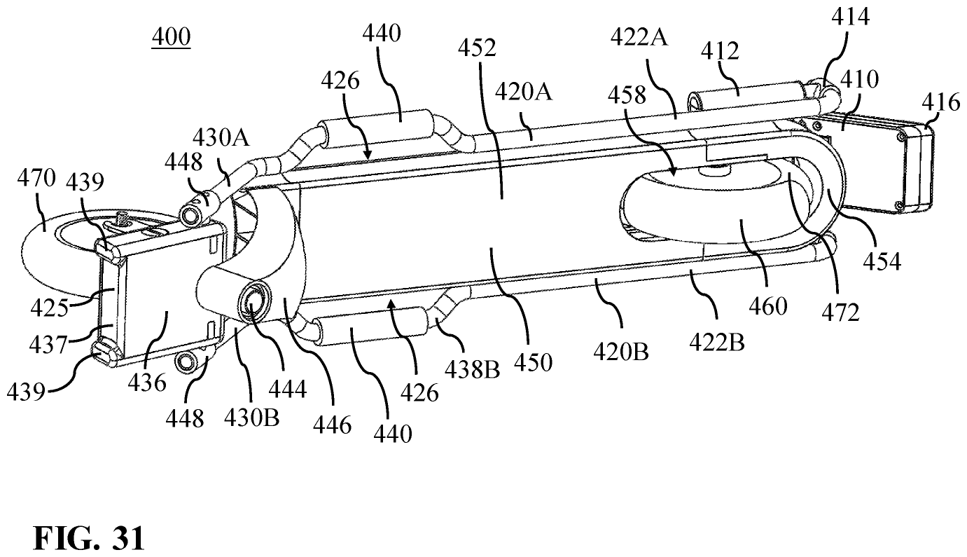

As seen in FIG. 31, stem members 420A and 420B are spaced apart by bracket 436 and define a shape and width that is configured to encompass base 450 within opening 426 when personal mobility device 400 is in the folded configuration. For example, as shown in FIG. 31, end portions 422A, 422B, 430A and 430B and handle members 438A and 438B are disposed adjacent to and aligned with base 450 in the folded configuration, with end portions 430A and 430B defining a profile that extends up from base 450 toward bracket 436 to attach at joints 448. In addition, opening 426 is still accessible between handle members 438A and 438B and base 450 to allow a user to grasp grip portions 440 due to the greater width of opening 426 adjacent handle members 438A and 438B. Handles 412 are also disposed adjacent base 450 when personal mobility device 400 is in the folded configuration.

Base 450 comprises platform 452, sometimes referred to as a deck, an opening 458 that is configured to receive wheel 472 and a kick stand 459. Opening 458 also comprises a mechanism for attaching wheel 472 to base 450 such as, e.g., an axle 174 (FIG. 5) or other mechanism. In some embodiments, base 450 also comprises a fender 460 at least partially covering wheel 472 and a rear taillight 461 (FIG. 28) disposed in a rear end portion 454 of base 450 rearward of opening 458. For example, the rear taillight 461 may be disposed within the uniform profile of rear end portion 454 of base 450.

As shown in FIGS. 30-41, opening 426 is configured to at least partially receive wheel 472 and fender 460 when personal mobility device 400 is transitioned to the folded configuration such that stem 420 is adjacent base 450. In some embodiments, wheel 472 may be mounted on a suspension hinge such as, e.g., suspension hinge 176 (FIG. 7).

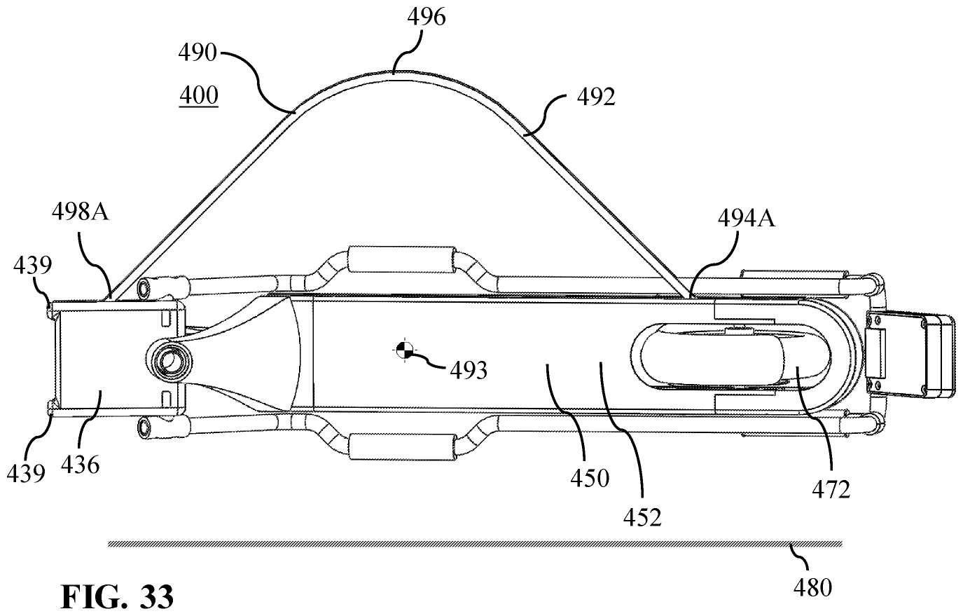

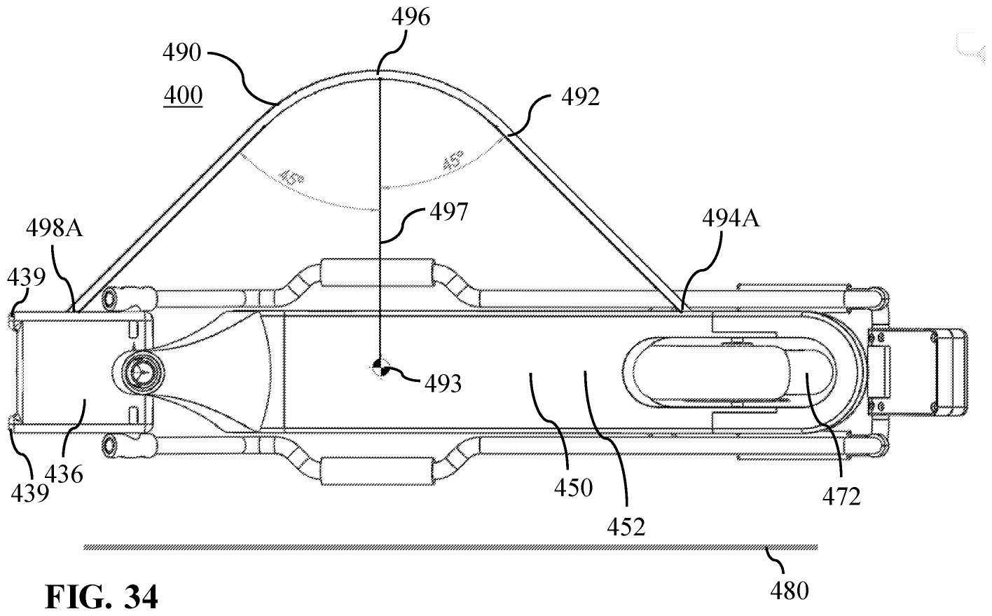

With reference to FIGS. 33 and 34, an embodiment of carrying mechanism 490 is disclosed that comprises a strap 492 attached to bracket 436 and base 450 at attachment locations 494A and 498A or in any other location. For example, in the embodiment shown in FIGS. 33 and 34, attachment locations 494A and 498A are on a side of bracket 436 and base 450. In the embodiment of FIGS. 33 and 34, strap 492 is attached such that a central portion 496 of strap 492 is disposed above a center of balance 493 of personal mobility device 400. In some embodiments, as shown in FIG. 34, an angle of strap when held by center portion 496 may define 45-degree angles towards attachment locations 494A and 498A relative to an axis 497 extending perpendicular to base 450 from center of balance 493 to center portion 496 of strap. In this manner, when a user holds strap 492 by center portion 496, personal mobility device 400 may be held in a balanced manner substantially parallel to surface 480 due to the relationship between strap 492 and center of balance 493.

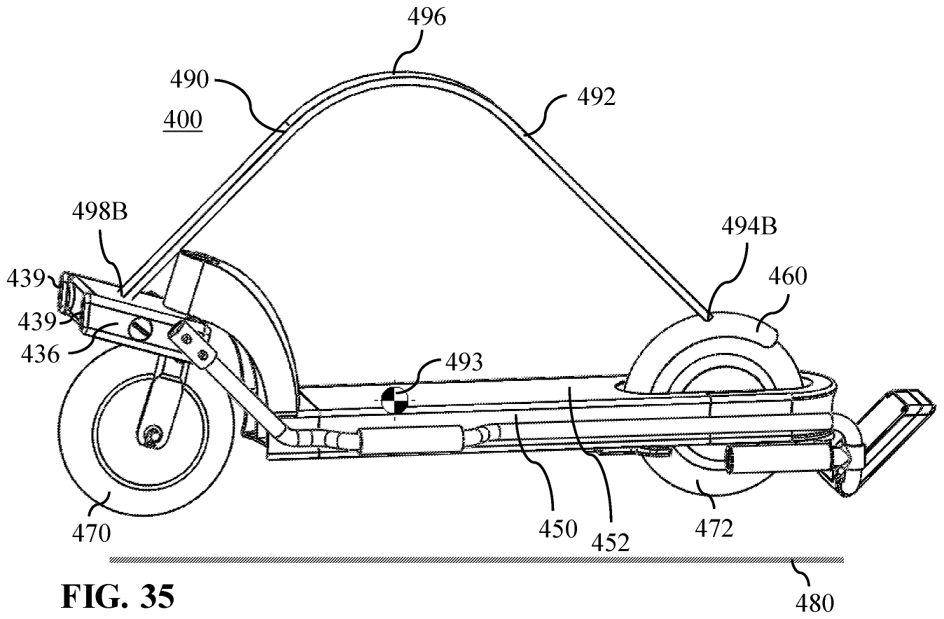

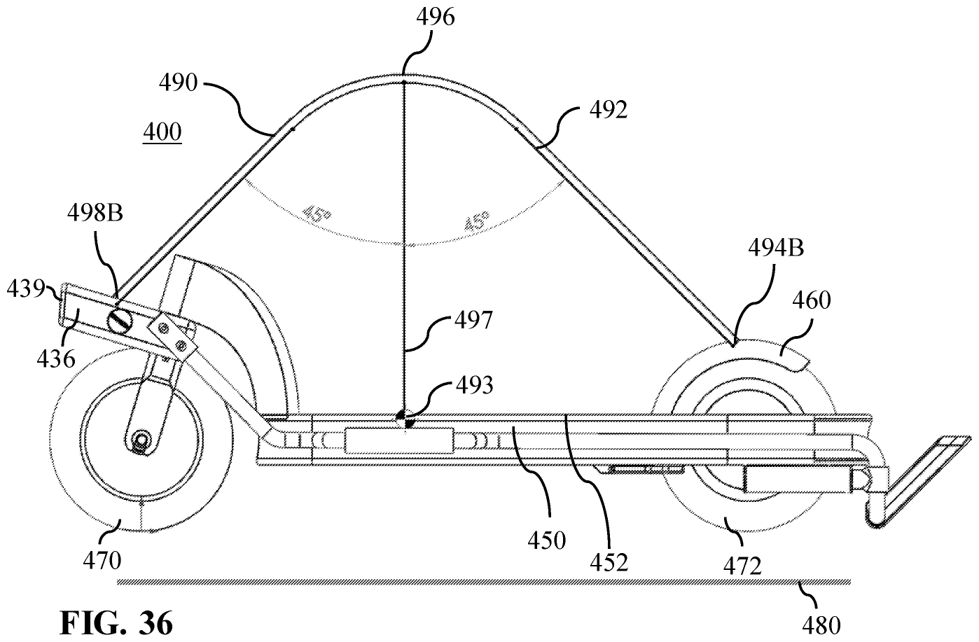

With reference to FIGS. 35 and 36, an embodiment of carrying mechanism 490 is disclosed that comprises strap 492 attached to bracket 436 and base 450 at attachment locations 494B and 498B or in any other location. For example, in the embodiment shown in FIGS. 35 and 36, attachment locations 494B and 498B are on a top surface of bracket 436 and base 450, e.g., on fender 460. In the embodiment of FIGS. 35 and 36, strap 492 is attached such that central portion 496 is disposed above center of balance 493 of personal mobility device 400. In some embodiments, as shown in FIG. 36, an angle of strap when held by center portion 496 may define 45-degree angles towards attachment locations 494B and 498B relative to an axis 497 extending perpendicular to base 450 from center of balance 493 to center portion 496 of strap. In this manner, when a user holds strap 492 by center portion 496, personal mobility device 400 may be held in a balanced manner substantially parallel to surface 480 due to the relationship between strap 492 and center of balance 493.

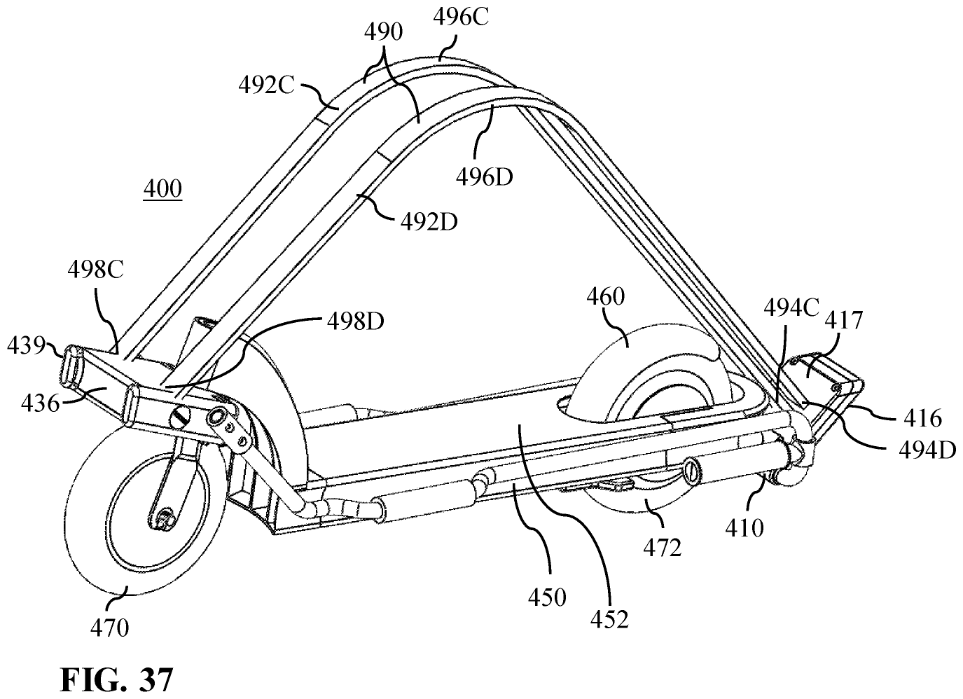

With reference to FIG. 37, an embodiment of carrying mechanism 490 is disclosed that comprises a pair of straps 492C and 492D attached to bracket 436 at attachment locations 494C, 494D and to handlebar 410 at attachment locations 498C and 498D or in any other location. Straps 492C and 492D may also collectively be referred to herein as strap 492 or straps 492 and may comprise any other features described herein with respect to strap 492 in other embodiments. For example, in the embodiment shown in FIG. 37, attachment locations 494C and 494D are on a top surface of bracket 436 and attachment locations 498C and 498D are on a bottom surface 417 of tray 416 of handlebar 410. In the embodiment of FIG. 37, straps 492C and 492D are attached such that central portions 496C and 496D are disposed above center of balance of personal mobility device 400. In this manner a user may comfortably carrying personal mobility device 400 by one or both of central portions 496C and 496D with personal mobility device 400 being balanced comfortably. In some embodiments, straps 492C and 492D may also or alternatively be used by a user to carry personal mobility device 400 on the user's back, e.g., in a similar manner to a backpack. In some embodiments, portions of personal mobility device 400 that may come into contact with the user's back when the user carries personal mobility device 400 as a backpack using straps 492C and 492D may be smooth, padded or configured in any other manner to provide comfortable carrying for the user.

In some embodiments, strap(s) 492 are permanently affixed to attachment locations 494A-D and 498A-D. In other embodiments, strap(s) 492 may be removably secured to any of attachment locations 494A-D and 498A-D or any other attachment locations, for example, using snap-fit, buckles, hook and loop fasteners, or in any other manner. In some embodiments, carrying mechanism 490 may be configured for automatic loosening and tightening or manual loosening and tightening in a similar manner to any of carrying mechanisms 190, 290 and 390 or in any other manner. In some embodiments, strap(s) 492 may be stored in bracket 436 or any other attachment location by a retraction mechanism such as, e.g., a retraction mechanism used for seat belts in automobiles. In some embodiments, strap(s) 492 may be extended from bracket 436 to base 450, handlebar 410, another portion of stem 420, any other portion of personal mobility device 400, or vice versa, and attached thereto, e.g., in a manner similar to the storage and extension of strap 592 described below for personal mobility device 500. In some embodiments, one or both of stem members 420A and 420B may comprise a smooth surface, padding, or both to facilitate a comfortable carry of personal mobility device 400 by the user when using strap(s) 492.

In addition to strap 492, a user may also carry personal mobility device 400 by grip portions 440 of handle members 438A and 438B when personal mobility device 400 is in the folded configuration. As seen in FIGS. 31 and 32, for example, when personal mobility device 400 is in the folded configuration, grip portions 440 of handle members 438A and 438B and opening 426 extend beyond the sides of base 450 such that a user is able to grasp one or both of grip portions 440 without their hand contacting base 450. In an illustrative embodiment, handle members 438A and 438B are located at center of balance 493 of personal mobility device 400 when personal mobility device 400 is in the folded configuration such that a user grasping one of grip portions 440 may easily carry personal mobility device 400 at the center of balance 493 which may inhibit additional strain on the user's hands or wrists. As an example, when personal mobility device 400 is positioned on its side as shown in FIG. 32, the top grip portion 440 may be disposed parallel to base 450 and perpendicular to an axis 495 extending perpendicular to base 450 from center of balance 493 to grip portion 440. In this manner, when a user holds the top grip portion 440 in FIG. 32, personal mobility device 400 may be held in a balanced manner substantially parallel to surface 480 due to the relationship between the top grip portion 440 and center of balance 493.

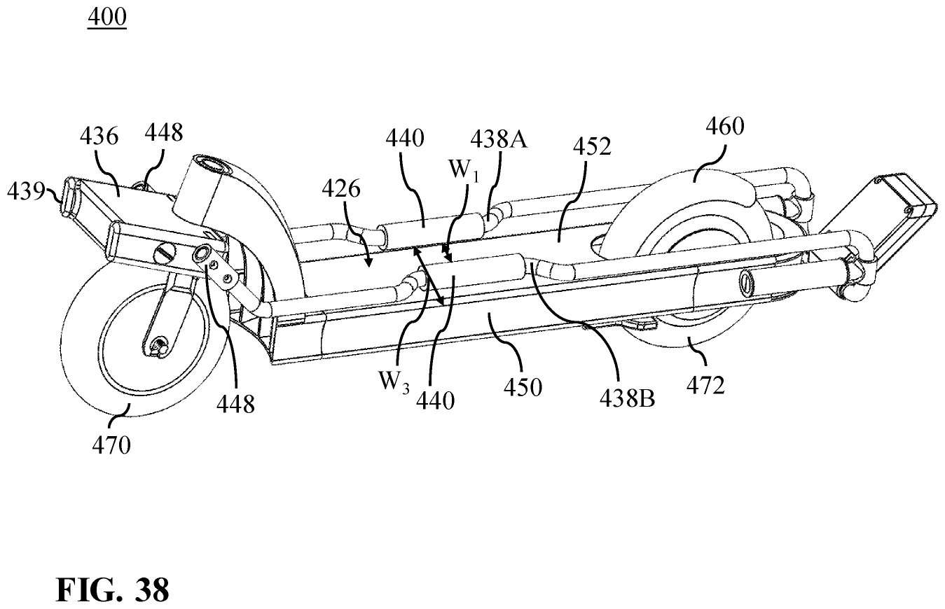

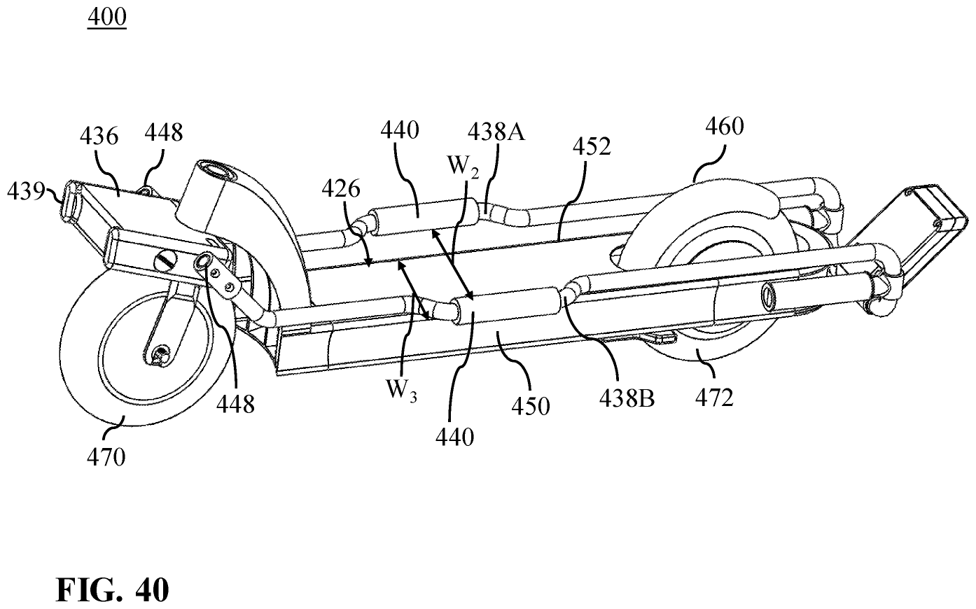

In another embodiment, as seen in FIGS. 38-40, grip portions 440 of handle members 438A and 438B are configured to transition between a first configuration (FIG. 38) in which the grip portions 440 of each handle member 438A and 438B are oriented toward each other and define a width W₁ therebetween and a second configuration (FIG. 40) in which the grip portions 440 of each handle member 438A and 438B are oriented away from each other and define a width W₂therebetween that is greater than the width W₁. In some embodiments, the width W₁ is smaller than a width W₃ of base 450 adjacent handle members 438A and 438B when in the folded configuration while width W₂is greater than width W₃ of base 450 adjacent handle members 438A and 438B when in the folded configuration. As shown in FIGS. 38-40, grip portions 440 are configured to transition between the first configuration (FIG. 38) and the second configuration (FIG. 40) by rotating about stem 420, e.g., as seen in the progression between FIGS. 38-40.

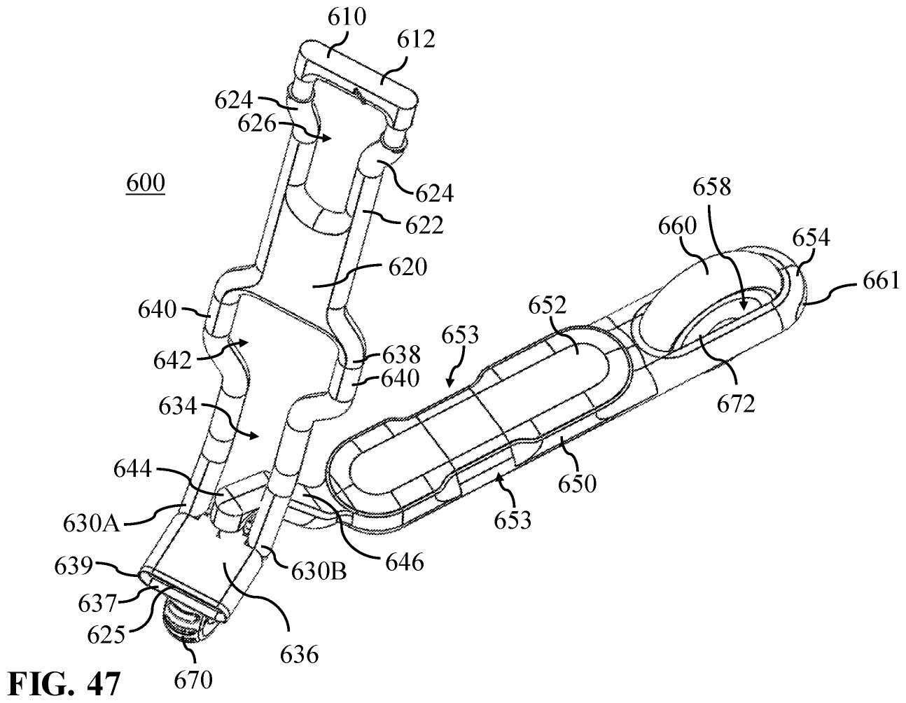

In some embodiments, the stem 420 may be offset relative to base 450 when in the folded configuration such that grip portions 440 are transitioned between the first configuration and the second configuration above base 450, e.g., as shown in FIGS. 38-40. In other embodiments, the stem 420 may positioned adjacent to base 450 when in the folded configuration, e.g., such as shown in FIGS. 31 and 32, and base 450 may comprise recessed portions adjacent to handle members 428A and 438B, e.g., similar to recessed portions 653 shown in FIG. 47, that are configured and dimensioned to receive grip portions 440 when in the first configuration (FIG. 38) and to provide space for a user's hand to grasp grip portions 440 when grip portions 440 are in the second configuration (FIG. 40).

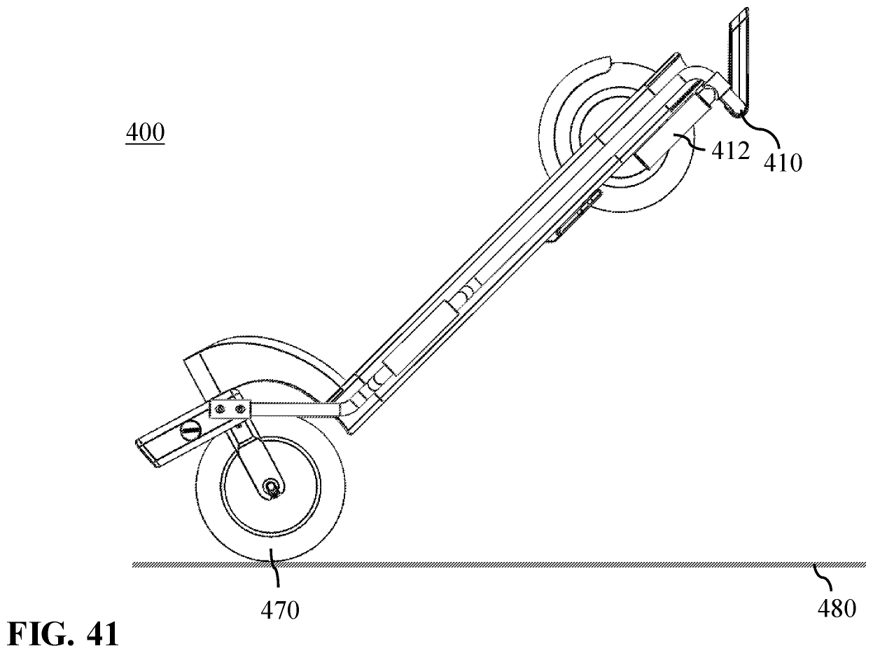

With reference now to FIG. 41, wheel 470 is available in the folded configuration to engage against a surface 480 such as, e.g., a floor, road, sidewalk, etc. In this configuration, a user may pull personal mobility device 400 using handlebar 410 while allowing wheel 470 to roll on the ground, in a similar manner to pulling a piece of luggage. In this configuration, the user may grasp handle 410 with a portion of the user's hand extending into or through opening 426 of stem 420 for ease of comfort and a stable, centrally aligned pulling position. Alternatively, the user may grasp one or both of handles 412 to pull personal mobility device 400.

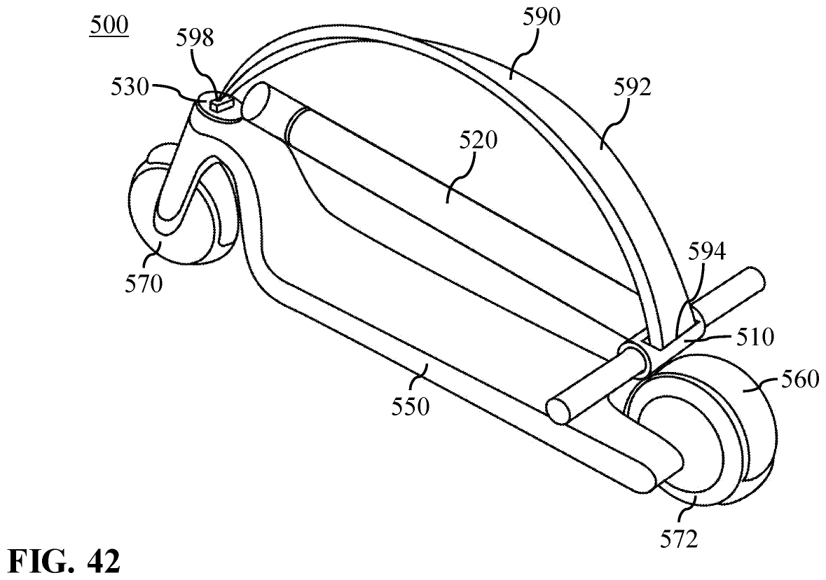

With reference to FIGS. 42-46, an example embodiment of a personal mobility device 500 is disclosed. Personal mobility device 500 is configured to provide a user with personal mobility, e.g., personal transportation from place to place. In an illustrative embodiment, personal mobility device 500 comprises a scooter, e.g., as shown in FIG. 42. In other embodiments, personal mobility device 500 may comprise other devices that may be used to transport a user including bicycles, skateboards, unicycles, hoverboards, tricycles, 3-wheels, ride-ons, strollers, carts or any other personal mobility device. In some embodiments, personal mobility device 500 comprises a user powered personal mobility device, e.g., movement of the personal mobility device is caused by physical effort of the user such as by kicking, dragging, running, pushing or otherwise driving a movement of personal mobility device. In some embodiments, personal mobility device 500 comprises a powered personal mobility device, e.g., comprising an electric or other type of motor that is configured to cause movement of personal mobility device 500 by driving one or more of the wheels of personal mobility device 500 or in any other manner.

In some embodiments, personal mobility device 500 may comprise some features or components that are similar to those found on one or more of personal mobility devices 100, 200, 300, 400 and 600. Where possible, similar features and components will be referred to with similar reference numbers. In addition, any of the features or features described herein with respect to personal mobility devices 100, 200, 300, 400 and 600 may be utilized in personal mobility device 500 and vice versa in various embodiments without departing from the scope of the present disclosure.

Personal mobility device 500 comprises a handlebar 510, a stem 520, a base 550, a wheel 570, a wheel 572 and a carrying mechanism 590. In other embodiments, other configurations may alternatively be utilized including, e.g., an alternate handlebar 510, stem 520, base 550, wheels 570 and 572, carrying mechanism 590 or any other alternative components or configurations including those shown in the other embodiments provided herein.

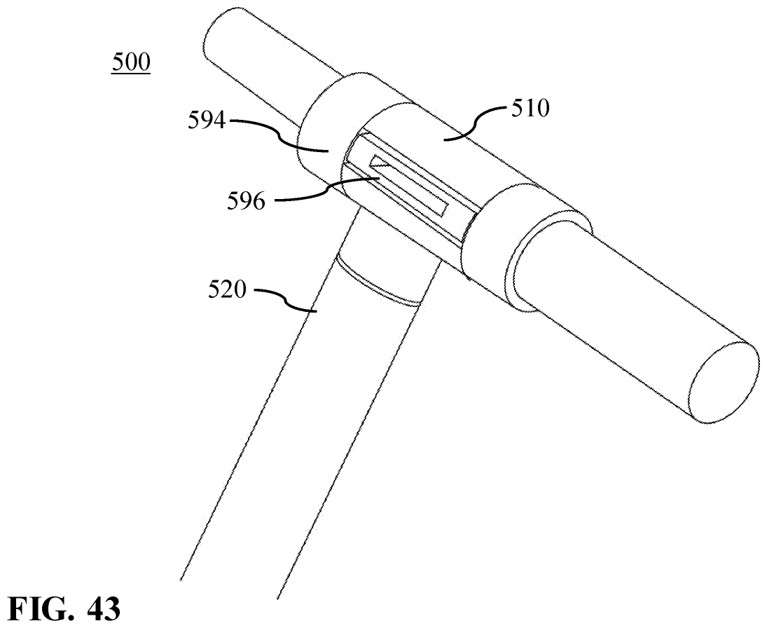

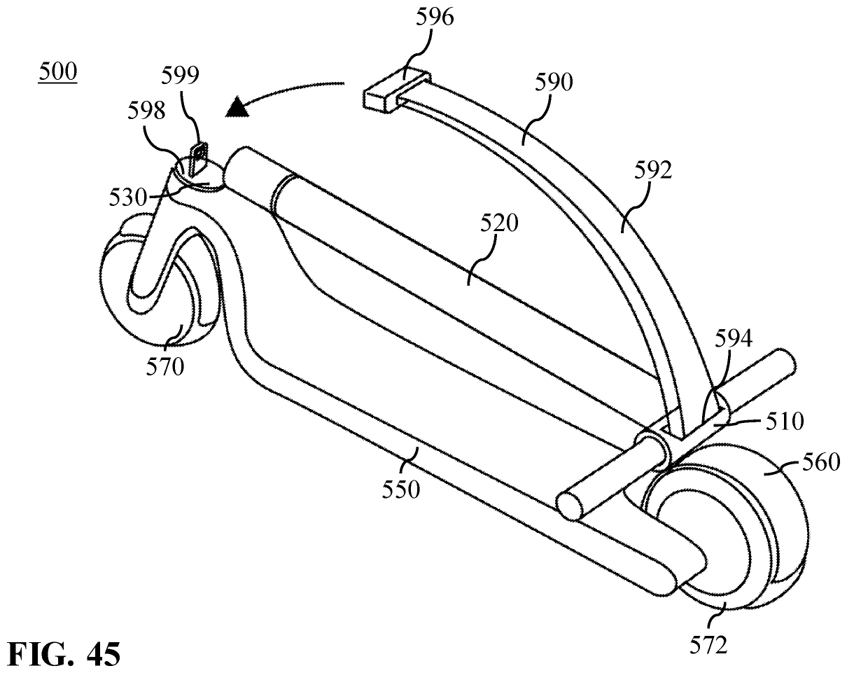

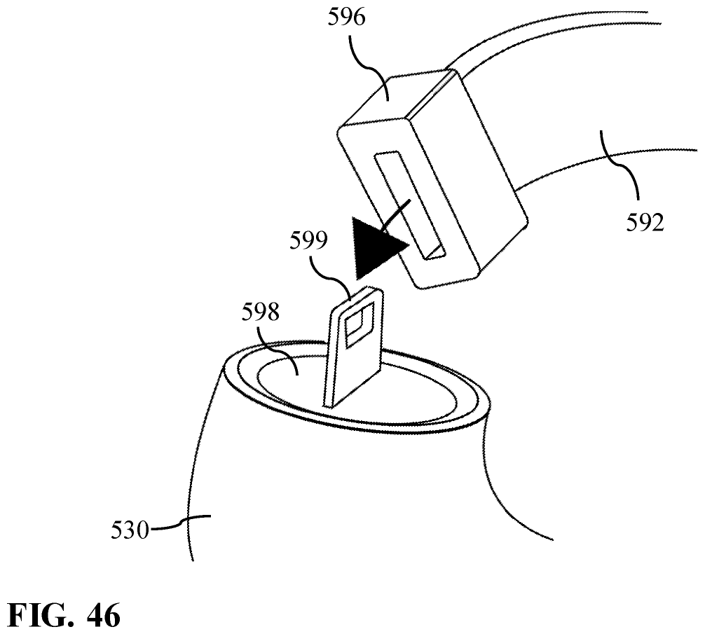

Carrying mechanism 590 comprises a strap 592 attached to handlebar 510 at an attachment location 594. In other embodiments, an alternative attachment location 594 such as, e.g., stem 520, base 550, fender 560 or any other location may be utilized. In some embodiments, strap 592 may be retracted and stored in attachment location 594, e.g., in a similar manner to a seatbelt in an automobile, as shown, for example, in FIG. 42. A user may grasp strap 592, e.g., at a buckle portion 596 and pull-on strap 592 to extend strap 592 towards an attachment location 598 located on an end portion 530 of stem 520 as shown in FIGS. 43-46. Attachment location 598 comprises a corresponding buckle portion 599 for removably attaching buckle portion 596, e.g., as seen in FIGS. 45 and 46. As an example, buckle portions 596 and 599 may comprise any mechanism for attaching strap 592 to attachment location 598 including, e.g., snap-fit, buckles, hook and loop fasteners, or in any other attachment mechanism. As shown in FIG. 42, with buckle portions 596 and 599 attached together, strap 592 is ready for carrying.

In an illustrative embodiment, stem 520 is foldable by a hinge 532 near attachment location 598 to transition personal mobility device 500 from the open configuration to the folded configuration. Folding of stem 520 at hinge 532 toward base 550 exposes buckle portion 599, which is otherwise received within stem 520 when personal mobility device 500 is in the open configuration. In other embodiments, attachment location 598 and buckle portion 599 may be exposed even when personal mobility device 500 is in the open configuration, e.g., may be on an outer surface of stem 520, near to end portion 530 of stem 520, part of base 550 or any other location.

While strap 592 is described and shown in the embodiment of FIGS. 42-46 as retracting into and extending from attachment location 594 in handlebar 510 to attach to attachment location 598 using buckle portions 596 and 599, in other embodiments, strap 592 may alternatively retract into and extend from attachment location 598 in stem 520 and attach to attachment location 594 using buckle portions 596 and 599. In yet other embodiments, strap 592 may extend from, retract into and attach to any other attachment locations in personal mobility device 500 including the sides of base 550, fender 560, bracket 536 or any other location.

With reference to FIG. 47, an example embodiment of a personal mobility device 600 is disclosed. Personal mobility device 600 is configured to provide a user with personal mobility, e.g., personal transportation from place to place. In an illustrative embodiment, personal mobility device 600 comprises a scooter, e.g., as shown in FIG. 47. In other embodiments, personal mobility device 600 may comprise other devices that may be used to transport a user including bicycles, skateboards, unicycles, hoverboards, tricycles, 3-wheels, ride-ons, strollers, carts or any other personal mobility device. In some embodiments, personal mobility device 400 comprises a user powered personal mobility device, e.g., movement of the personal mobility device is caused by physical effort of the user such as by kicking, dragging, running, pushing or otherwise driving a movement of personal mobility device. In some embodiments, personal mobility device 600 comprises a powered personal mobility device, e.g., comprising an electric or other type of motor that is configured to cause movement of personal mobility device 600 by driving one or more of the wheels of personal mobility device 600 or in any other manner.

In some embodiments, personal mobility device 600 may comprise some features or components that are similar to those found on one or more of personal mobility devices 100, 200, 300, 400 and 500. Where possible, similar features and components will be referred to with similar reference numbers. In addition, any of the features or features described herein with respect to personal mobility devices 100, 200, 300, 400 and 500 may be utilized in personal mobility device 600 and vice versa in various embodiments without departing from the scope of the present disclosure.

Personal mobility device 600 comprises a handlebar 610, a stem 620, a base 650, a wheel 670 and a wheel 672. In other embodiments, other configurations may alternatively be utilized including, e.g., an alternate handlebar 610, stem 620, base 650, wheel 670 and wheel 672 or any other alternative components or configurations including those shown in the other embodiments provided herein.

Handlebar 610 comprises a handle 612 that is configured for grasping by a user of personal mobility device 600. Handlebar 610 is attached to end portion 622 of stem 620. In some embodiments, for example, end portion 622 may have bent portions 624 in proximity to handlebar 610. In some embodiments, handlebar 610 is integrated as part of stem 620 with handle 612 being attached to stem 620 adjacent bent portions 424.

In some embodiments, stem 620 defines an opening 626. Opening 626 provides a hole through which an object may be passed between handlebar 610 and stem 620, e.g., a hand or another object.

Stem 620 also comprise end portions 630A and 630B opposite end portion 622. End portions 630A and 630B are attached to a bracket 636 that is attached to wheel 670. Bracket 636 is configured to engage with wheel 670 to enable rotation of wheel 670 about a central axis of wheel, e.g., using an axle or another component, during movement of personal mobility device 600. In some embodiments, bracket 636 comprises a stand 637 extending toward a front of personal mobility device 600 that is configured, in conjunction with wheel 670, for engagement against a surface to stand up personal mobility device 600 and inhibit personal mobility device 600 from falling when in the folded configuration. The spacing between wheel 670 and stand 637 when wheel 670 and stand 637 are engaged against a surface provides stability to personal mobility device 600 when standing and may be sized as needed to provide the desired level of stability. In some embodiments, stand 637 comprises a rim 639 that is configured to engage against the surface. In an illustrative embodiment, the attachment of stem 620 to bracket 636 is offset from the axis of rotation of wheel 670. In some embodiments, stand 637 comprises a headlight 625, e.g., battery powered or powered in another manner, that is configured to illuminate an area in front of personal mobility device 600.

Stem member 620 further comprises handle members 638 disposed between end portion 622 and end portions 630A and 630B. In an illustrative embodiment, handle members 638 comprise grip portions 640 that are laterally offset relative to the rest of stem 620, for example, as shown in FIG. 47. In some embodiments, stem 620 comprises an opening 642 between end portions 630A and 630B and handle members 638, where opening 642 is wider adjacent to handle members 638 to enable objects, e.g., a user's fingers during carrying, to pass through opening 626 adjacent handle members 638 when personal mobility device 600 is in the folded configuration.

Stem 620 is attached to base 650 by bracket 636 at a joint 644 that allows stem 620 to rotate about a longitudinal axis of joint 644 to rotate wheel 670 relative to base 650, e.g., for turning personal mobility device 600. In some embodiments, for example, joint 644 comprises a pin and tube or another mechanism about which bracket 636 is configured to rotate to rotate wheel 670 relative to base 650 and turn personal mobility device 600. Joint 644 is attached to base 650 by a flange 646.

Stem 620 is configured to fold relative to base 650 via the attachment of stem 620 to bracket 636, e.g., in a similar manner to that shown for personal mobility device 200 in FIGS. 9 and 10.

Base 650 comprises platform 652, sometimes referred to as a deck, an opening 658 that is configured to receive wheel 672. Opening 658 also comprises a mechanism for attaching wheel 672 to base 650 such as, e.g., an axle 174 (FIG. 5) or other mechanism. In some embodiments, base 650 also comprises a fender 660 at least partially covering wheel 672 and a rear taillight 661 disposed in a rear end portion 654 of base 650 rearward of opening 658. For example, the rear taillight 661 may be disposed within the uniform profile of rear end portion 654 of base 650.

Opening 626 is configured to at least partially receive wheel 672 and fender 660 when personal mobility device 600 is transitioned to the folded configuration such that stem 620 is adjacent base 650. In some embodiments, wheel 672 may be mounted on a suspension hinge such as, e.g., suspension hinge 176 (FIG. 7).

A user may carry personal mobility device 600 by grip portions 640 of handle member 638 when personal mobility device 600 is in the folded configuration. In an illustrative embodiment, base 650 comprises recessed portions 653 that are configured to be aligned with handle members 638 and grip portions 640 when personal mobility device 600 is in the folded configuration. For example, when personal mobility device 600 is in the folded configuration, grip portions 640 of handle member 638 and opening 642 extend beyond the sides of recessed portions 653 of base 650 such that a user is able to grasp one or both of grip portions 640 without their hand contacting base 650, e.g., by positioning their hand within the recessed portions 653. In some embodiments, a width between handle members 638 may be smaller than a width of base 650 generally but greater than width of base 650 at recessed portions 653. In an illustrative embodiment, handle member 638 is located at a center of balance of personal mobility device 600 when personal mobility device 600 is in the folded configuration such that a user grasping one of grip portions 640 may easily carry personal mobility device 600 at the center of balance which may inhibit additional strain on the user's hands or wrists.

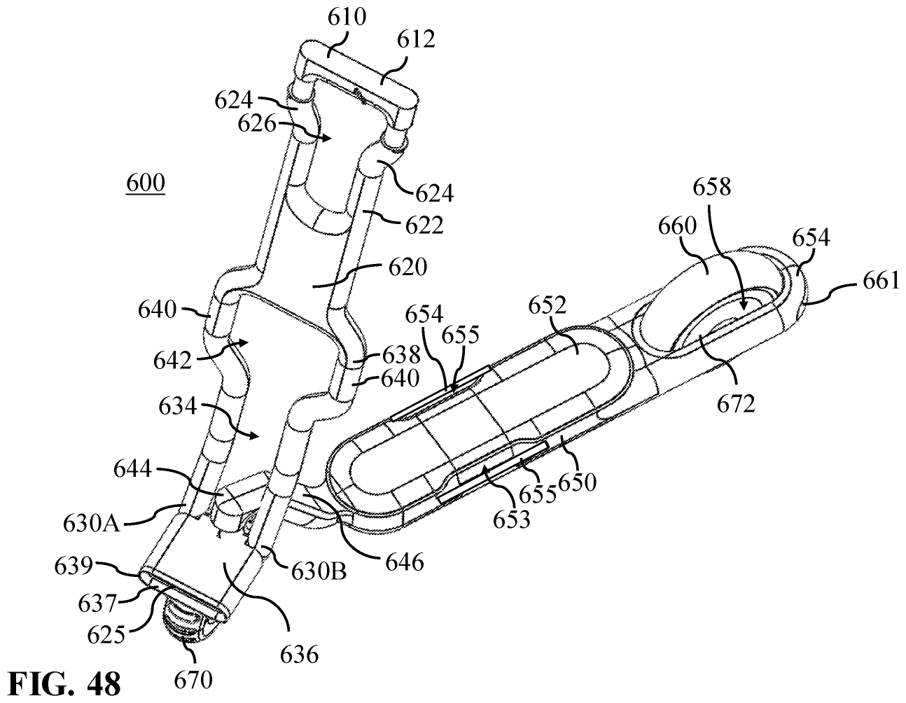

With reference to FIG. 48, in some embodiments, base may comprise grip portions 655 extending across recessed portions 653 such that, for example, a user may grasp grip portions 655 of base 650 to carry personal mobility device 600 in a similar manner to grip portions 640. In some embodiments, grip portions 655 of base 650 may be utilized instead of grip portions 640 of stem 620. In some embodiments, grip portions 655 are disposed proximate to a center of gravity of personal mobility device 600 when stem 620 is in the folded configuration. In illustrative embodiments, any of personal mobility devices 100, 200, 300, 400 and 500 comprise recessed portions 653 or a combination of recessed portions 653 with grip portions 655 in addition to or alternatively to their corresponding handle members, grip portions or integrated carrying mechanisms.

FIGS. 1 through 48 are conceptual illustrations allowing for an explanation of the disclosed embodiments of the invention. Notably, the figures and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A personal mobility device comprising:
a wheel;
a stem;
a base, the stem being configured to fold relative to the base to transition the personal mobility device between an open configuration and a folded configuration; and
an integrated carrying mechanism attached to the personal mobility device, the integrated carrying mechanism comprising a flexible material that is configured for use by a user to carry the personal mobility device when in the folded configuration.

2. The personal mobility device of claim 1 wherein:
the integrated carrying mechanism is tensioned when the personal mobility device is in the open configuration and is configured to automatically loosen when the personal mobility device is transitioned from the open configuration to the folded configuration.

3. The personal mobility device of claim 1 wherein the integrated carrying mechanism is attached to the stem at a first attachment location and attached to the base at a second attachment location, the integrated carrying mechanism extending from the first attachment location to the second attachment location through an opening of the stem.

4. The personal mobility device of claim 3 wherein a distance between the first attachment location and the second attachment location in the open configuration is greater than the distance between the first attachment location and the second attachment location in the folded configuration.

5. The personal mobility device of claim 3 wherein the stem comprises a member extending across the opening, the integrated carrying mechanism being tensioned against the member when the personal mobility device is in the open configuration and loosened relative to the member when the personal mobility device is in the folded configuration.

6. The personal mobility device of claim 1 wherein:
the flexible material comprises a first flexible material; and
the integrated carrying mechanism comprises a second flexible material, the second flexible material being configured for use by a user to carry the personal mobility device when in the folded configuration.

7. The personal mobility device of claim 1 wherein the integrated carrying mechanism is attached to the personal mobility device at a first attachment location and at a second attachment location, the flexible material being tensioned toward at least one of the first attachment location and the second attachment location.

8. The personal mobility device of claim 1 wherein the integrated carrying mechanism is fixedly attached to a first attachment location of the personal mobility device and removably attached to a second attachment location of the personal mobility device.

9. The personal mobility device of claim 8 wherein the first attachment location and the second attachment location are on the stem.

10. The personal mobility device of claim 8 wherein the first attachment location is on a handlebar of the stem and the second attachment location is on a bracket coupling the stem to the base.

11. The personal mobility device of claim 8 wherein the integrated carrying mechanism is configured for retraction to the first attachment location.

12. A personal mobility device comprising:
a base;
a stem comprising a first end portion and a second end portion;
a handlebar coupled to the first end portion of the stem; and
a folding mechanism coupled to the second end portion of the stem and being configured to transition the stem between an open configuration and a folded configuration, the first and second end portions of the stem being disposed proximate to the base when the stem is in the folded configuration, the stem comprising a handle portion disposed between the folding mechanism and the handlebar, the handle portion being disposed proximate to a center of gravity of the personal mobility device.

13. The personal mobility device of claim 12 wherein the stem comprises an opening between a first arm and a second arm, the stem being configured to receive at least a portion of the base in the opening when the stem is in the folded configuration such that the first and second arms are disposed on opposite sides of the portion of the base.

14. The personal mobility device of claim 12 wherein the handle portion of the stem is configured to transition between a first configuration and a second configuration, the stem at the handle portion having a width that is greater than a corresponding portion of the base when the handle portion is in the first configuration and a width that is smaller than the corresponding portion of the base when the handle portion is in the second configuration.

15. The personal mobility device of claim 12 wherein the base comprises a recess located proximate to the handle portion of the stem when the stem is in the folded configuration, the recess being configured to receive a portion of a user's hand when the user grasps the handle portion of the stem.

16. A personal mobility device comprising:
a base;
a stem;
a bracket coupled to the stem;
a wheel coupled to the bracket; and
a folding mechanism coupled to the bracket, the folding mechanism being configured to transition the stem from an open configuration to a folded configuration, the stem being disposed proximate to the base when in the folded configuration, the wheel extending forward of the base when the stem is in the folded configuration, the bracket comprising a standing surface that extends forward of the base at least as far forward as the wheel when the stem is in the folded configuration.

17. The personal mobility device of claim 16 wherein:
the standing surface is configured for engagement against an environmental surface such that a longitudinal axis of the base is transverse to the environmental surface when the stem is in the folded configuration;
the standing surface is configured to inhibit the personal mobility device from falling over when the standing surface is engaged against the environmental surface; and
the standing surface defines a plane of contact for engaging the environmental surface.

18. A personal mobility device comprising:
a stem;
a base, the stem being configured to fold relative to the base to transition the personal mobility device between an open configuration and a folded configuration; and
an integrated carrying mechanism attached to the stem at a first attachment location and to the base at a second attachment location, the integrated carrying mechanism being configured to automatically tension against a portion of the stem when the personal mobility device is transitioned to the open configuration and to automatically loosen when the personal mobility device transition to the folded configuration.

19. The personal mobility device of claim 18 wherein:
the integrated carrying mechanism extends through an opening in the stem, the integrated carrying mechanism being tensioned against a side of the opening when the personal mobility device is in the open configuration and loosened relative to the side of the opening when the personal mobility device is in the folded configuration.

20. The personal mobility device of claim 19 wherein the opening is disposed a first distance from the second attachment location when the personal mobility device is in the open configuration and a second distance from the second attachment location when the personal mobility device is in the folded configuration, the second distance being smaller than the first distance.

21. A personal mobility device comprising:
a wheel;
a fender covering a first portion of the wheel;
an integrated cover, the integrated cover being configured to selectively cover a second portion of the wheel;
a base comprising a body and a distal portion extending from the body; and
a stem foldable relative to the base to transition the personal mobility device between an open configuration and a folded configuration, the wheel being coupled to the distal portion, the wheel being rotatable about a longitudinal axis of the distal portion between a first position and a second position, the wheel being configured to lay flat adjacent the stem when the personal mobility device is in the folded configuration.

22. A personal mobility device comprising:
a base;
a stem; and
a folding mechanism that is configured to transition the stem from an open configuration to a folded configuration, the stem being configured to fold flat against the base when in the folded configuration, wherein the folding mechanism comprises a first joint coupled to the stem and a second joint coupled to the base, the folding mechanism being configured to rotate about each of the first and second joints to fold the stem flat against the base.

23. The personal mobility device of claim 22 wherein the stem and wheel together are configured to move in a rearward direction toward the base when the stem is transitioned from the open configuration to the folded configuration.

24. The personal mobility device of claim 23 wherein the stem members comprise standing surfaces, the standing surfaces being exposed forward of the wheel when the stem is in the folded configuration, the standing surfaces being configured for standing the personal mobility device on a surface separate from the personal mobility device and to inhibit the personal mobility device from falling over.

25. A personal mobility device comprising:
a base comprising a platform, a first side, and a second side opposite the first side;
a bracket coupled to the base by a first joint, the bracket being coupled to a wheel;
a first stem member coupled to the bracket by a second joint, the first stem member being rotatable about the second joint to transition the personal mobility device from an open configuration to a folded configuration, the first stem member being disposed adjacent to the first side of the base when the personal mobility device is in the folded configuration; and
a second stem member coupled to the bracket by a third joint, the second stem member being rotatable about the third joint to transition the personal mobility device from the open configuration to the folded configuration, the second stem member being disposed adjacent to the second side of the base when the personal mobility device is in the folded configuration.
